(19) United States
(12) Patent Application Publication
(10) Pub. No.: US 2006/0219607 A1
(43) Pub. Date: Oct. 5, 2006

(54) Substrate for electronic device and method of manufacturing the same

(75) Inventors: Mitsuru Sato, Suwa (JP); Ryo Matsushita, Higashiura (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/366,733

(22) Filed: Mar. 2, 2006

(30) Foreign Application Priority Data
Mar. 15, 2005 (JP) 2005-073890

(51) Int. Cl. B03C 1/00

(52) U.S. Cl. 209/221

(57) ABSTRACT

A substrate for an electronic device according to the present invention includes a base substrate and a switching device formed on the base substrate. The switching device has a terminal. The substrate also includes an interlayer dielectric formed so as to cover the switching device. The interlayer dielectric has a contact hole extending therethrough so as to communicate with the terminal of the switching device. The substrate has a pixel electrode formed on the interlayer dielectric and an electrically connecting portion connected to the pixel electrode. The electrically connecting portion includes a conductive film formed on an inner surface of the contact hole and a surface of the terminal by a vapor phase process. The electrically connecting portion also includes a filler material filled in a space inside of the conductive film within the contact hole.

### CROSS-REFERENCE TO RELATED APPLICATION

This application claims priority to Japanese Patent Application No. 2005-73890 filed Mar. 15, 2005, which is hereby expressly incorporated by reference herein in its entirety.

### BACKGROUND OF THE INVENTION

1. Field of the Invention

The present invention relates to a substrate for an electronic device and a method of manufacturing a substrate for an electronic device. The present invention also relates to a display device having such a substrate. Further, the present invention relates to an electronic device having such a display device.

2. Description of the Related Art

For example, in an active matrix dynamic display device, pixel electrodes are formed above switching devices and an interlayer dielectric so as to correspond to the respective switching devices. Each of the pixel electrodes is electrically connected to each terminal of the switching device by a connecting portion provided in a contact hole.

For example, a method of forming such pixel electrodes and connecting portions is disclosed by Japanese laid-open patent publication No. 8-263016. Such a conventional method of forming pixel electrodes and connecting portions includes etching a transparent conductive film, which is formed by a sputtering method (vapor phase process), to integrally form pixel electrodes and connecting portions.

However, a transparent conductive film formed by a vapor phase process has a uniform thickness. Accordingly, as shown in FIG. 1, a transparent conductive film 510 is also formed on an inner surface of the contact hole 501, which reaches a terminal 503. Thus, a space 502 is formed within the contact hole 501. Specifically, the contact hole 501 is not filled with the connecting portion 510, and the space 502 is left within the contact hole 501.

For example, when such a display device is applied to a transmissive liquid crystal display device, an alignment layer is formed so as to cover the pixel electrodes (including the connecting portions 510) and the interlayer dielectric 504. At that time, recesses are formed in the alignment layer at positions corresponding to the contact holes 501. In such a case, when a rubbing process is performed on the alignment layer, fragments (broken pieces) of the alignment layer produced by rubbing enter and accumulate in the recesses of the alignment layer. Accordingly, the orientation of the liquid crystal layer is deteriorated at locations at which the fragments are present. As a result, the liquid crystal display device has display unevenness.

Further, when such a display device is applied to an electrophoresis display device having microcapsules, the microcapsules are deformed because of the presence of the space 502. Accordingly, the electrophoresis display device has display unevenness.

### SUMMARY

The present invention has been made in view of the above drawbacks. It is, therefore, a first object of the present invention to provide a substrate for an electronic device which can reduce display unevenness in a display device. A second object of the present invention is to provide a method of manufacturing such a substrate. A third object of the present invention is to provide a display device having such a substrate. A fourth object of the present invention is to provide an electronic device having such a display device with high reliability. These objects can be attained by the present invention as follows.

According to a first aspect of the present invention, there is provided a substrate for an electronic device which can reduce display unevenness in a display device. The substrate includes a base substrate and a switching device formed on the base substrate. The switching device has a terminal. The substrate also includes an interlayer dielectric formed so as to cover the switching device. The interlayer dielectric has a contact hole extending therethrough so as to communicate with the terminal of the switching device. The substrate has a pixel electrode formed on the interlayer dielectric and an electrically connecting portion connected to the pixel electrode. The electrically connecting portion includes a conductive film formed on an inner surface of the contact hole and a surface of the terminal by a vapor phase process. The electrically connecting portion also includes a filler material filled in a space inside of the conductive film within the contact hole.

When the substrate having the above arrangement is applied to, for example, a display device, display unevenness can reliably be reduced.

It is desirable that the filler material is filled by a liquid phase process. In this case, the filler material can be filled in a space within the contact hole with ease and reliability.

It is desirable that a surface of the electrically connecting portion which is opposite to the base substrate and a surface of the pixel electrode which is opposite to the base substrate are formed by a continuous smooth surface. When the substrate having the above arrangement is applied to, for example, a display device, display unevenness can reliably be prevented.

The conductive film of the electrically connecting portion and at least a portion of the pixel electrode may be formed integrally with each other. It is desirable that the pixel electrode has a light-transmittance. In this case, the substrate can be applied to a display device that requires pixel electrodes having a light-transmittance, such as a transmissive liquid crystal display device.

It is desirable that the filler material mainly contains a conductive material. In such a case, even if the filler material is supplied to a portion of the pixel electrode, the resistance of the pixel electrode can effectively be inhibited or prevented from being increased.

The filler material may principally contain a transparent conductive material. In such a case, even if the filler material is supplied to a portion of the pixel electrode, the pixel electrode can reliably have a transmittance while the resistance of the pixel electrode can effectively be inhibited or prevented from being increased.

The pixel electrode may include a portion to which the filler material is supplied on an opposite side of the base substrate.

According to a second aspect of the present invention, there is provided a method of manufacturing the above substrate. According to this method, a contact hole is formed in an interlayer dielectric covering a switching device formed on a base substrate so as to communicate with a terminal of the switching device. A conductive material is supplied by a vapor phase process to form a conductive material layer on the interlayer dielectric in a region including a formation area. A filler material is filled selectively in a space inside of the conductive material layer within the contact hole by a liquid phase process. A mask material is supplied by a liquid phase process to form a mask having a shape corresponding to the formation area. An unnecessary portion of the conductive material layer is removed with use of the mask to form a pixel electrode and an electrically connecting portion connected to the pixel electrode on the interlayer dielectric in the formation area. Thus, the above substrate can be manufactured.

Prior to filling of the filler material, a liquid-repellency to a liquid material used as the filler material may be improved on a surface of the conductive material layer opposite to the base substrate. In this case, the filler material can be filled selectively in the space.

Prior to supply of the mask material, a liquid-repellency to the mask material may be improved on a surface of the conductive material layer opposite to the base substrate in a region excluding the formation area. In this case, the mask can be formed selectively in the formation area.

According to a third aspect of the present invention, there is provided a method of manufacturing the above substrate. According to this method, a contact hole is formed in an interlayer dielectric covering a switching device formed on a base substrate so as to communicate with a terminal of the switching device. A conductive material is supplied by a vapor phase process to form a conductive material layer on the interlayer dielectric in a region including a formation area. A filler material is supplied by a liquid phase process to form a filler material layer on the conductive material layer. The filler material has a shape corresponding to the formation area. An unnecessary portion of the conductive material layer is removed while the filler material layer is used as a mask. An unnecessary portion of the filler material layer is removed to form a pixel electrode and an electrically connecting portion connected to the pixel electrode on the interlayer dielectric in the formation area. Thus, the above substrate can be manufactured.

Prior to supply of the filler material, a liquid-repellency to a liquid material used as the filler material may be improved on a surface of the conductive material layer opposite to the base substrate in a region excluding the formation area. In this case, the filler material layer can be formed selectively in the formation area.

According to a fourth aspect of the present invention, there is provided a method of manufacturing the above substrate. According to this method, a contact hole is formed in an interlayer dielectric covering a switching device formed on a base substrate so as to communicate with a terminal of the switching device. A conductive material is supplied by a vapor phase process to form a conductive material layer on the interlayer dielectric in a region including a formation area. A filler material is supplied by a liquid phase process to form a filler material layer on the conductive material layer. A mask material is supplied by a liquid phase process to form a mask having a shape corresponding to the formation area. Unnecessary portions of the filler material layer and the conductive material layer are collectively removed with use of the mask to form a pixel electrode and an electrically connecting portion connected to the pixel electrode on the interlayer dielectric in the formation area. Thus, the above substrate can be manufactured.

Prior to supply of the mask material, a liquid-repellency to the mask material may be improved on a surface of the filler material layer which is opposite to the base substrate in a region excluding the formation area. In this case, the mask can be formed selectively in the formation area.

According to a fifth aspect of the present invention, there is provided a display device having the above substrate. Display unevenness is reduced in such a display device.

According to a sixth aspect of the present invention, there is provided an electronic device including the above display device. Such an electronic device has high reliability.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a schematic view showing a connecting portion of a switching device formed by a conventional method;

FIG. 2 is an exploded perspective view showing a transmissive liquid crystal display device according to an embodiment of the present invention;

FIG. 3 is an enlarged cross-sectional view showing a thin-film transistor in the transmissive liquid crystal display device shown in FIG. 2;

FIG. 4 is an enlarged cross-sectional view showing a first example of an electrically connecting portion formed on the thin-film transistor shown in FIG. 3;

FIG. 5 is an enlarged cross-sectional view showing a second example of the electrically connecting portion formed on the thin-film transistor shown in FIG. 3;

FIGS. 6A through 6G are cross-sectional views explanatory of a method of forming a thin-film transistor according to a preferred embodiment of the present invention;

FIGS. 7A through 7I are schematic views (vertical cross-sectional views) explanatory of a method of manufacturing a substrate for an electronic device according to a first embodiment of the present invention;

FIGS. 8A through 8G are schematic views (vertical cross-sectional views) explanatory of a method of manufacturing a substrate for an electronic device according to a second embodiment of the present invention;

FIGS. 9A through 9K are schematic views (vertical cross-sectional views) explanatory of a method of manufacturing a substrate for an electronic device according to a third embodiment of the present invention;

FIG. 10 is a perspective view showing a portable (or notebook) personal computer having an electronic device according to the present invention;

FIG. 11 is a perspective view showing a cellular phone (including PHS) having an electronic device according to the present invention; and

FIG. 12 is a perspective view showing a digital still camera having an electronic device according to the present invention.

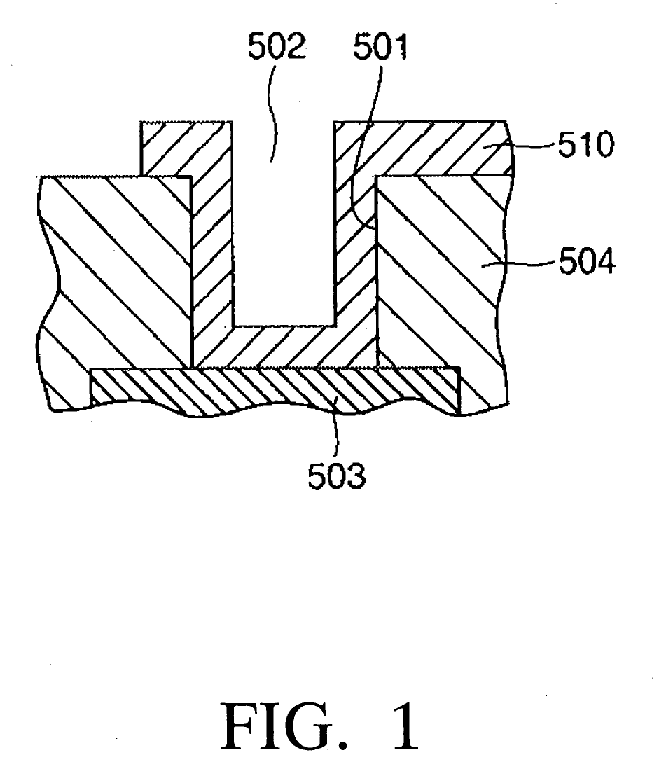

### DETAILED DESCRIPTION OF THE PREFERRED EMBODIMENTS

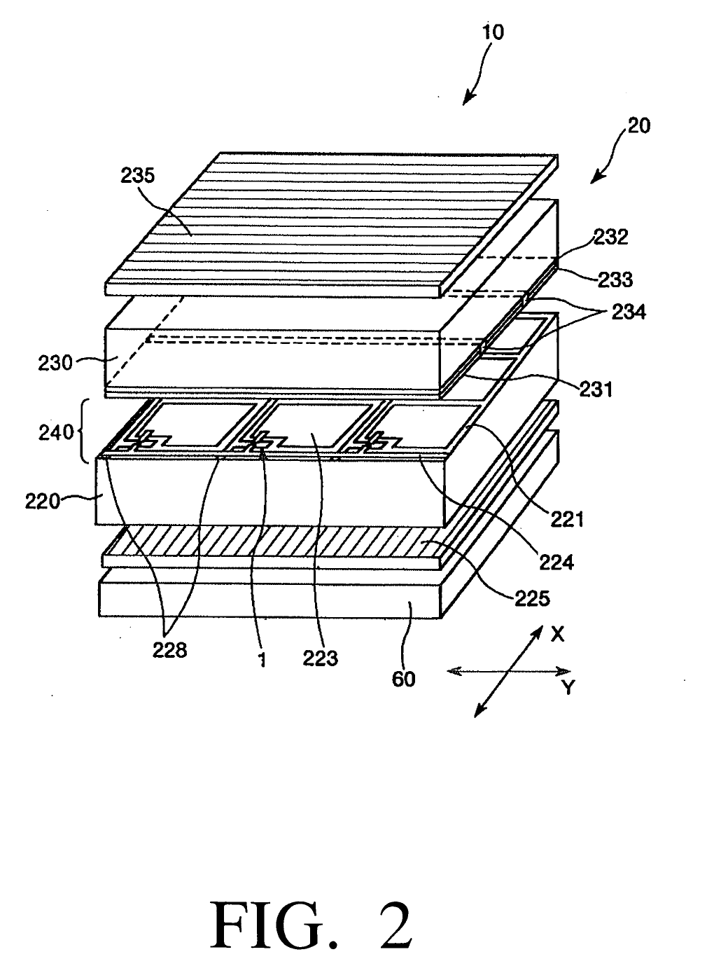

Embodiments of the present invention will be described below with reference to FIGS. 2 through 12. Like or corresponding parts are denoted by like or corresponding reference numerals throughout drawings, and will not be described below repetitively. Although an active matrix transmissive liquid crystal display device will be described as an example of a display device according to the present invention, the present invention is not limited to an active matrix transmissive liquid crystal display device.

1. Arrangement of a Transmissive Liquid Crystal Display Device

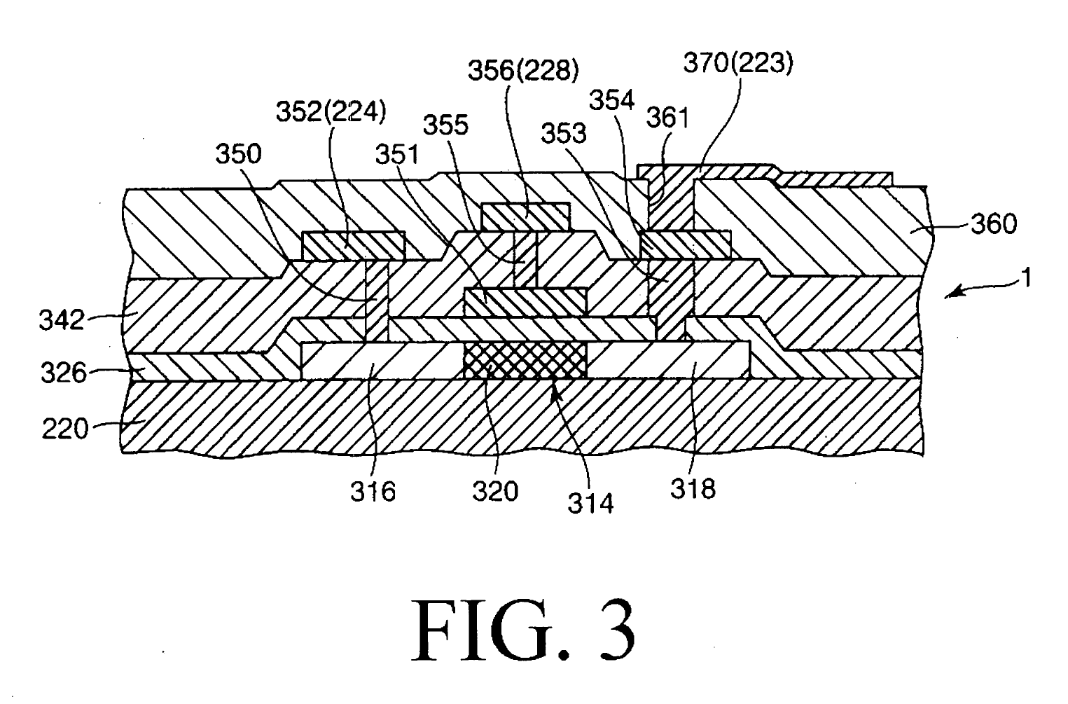

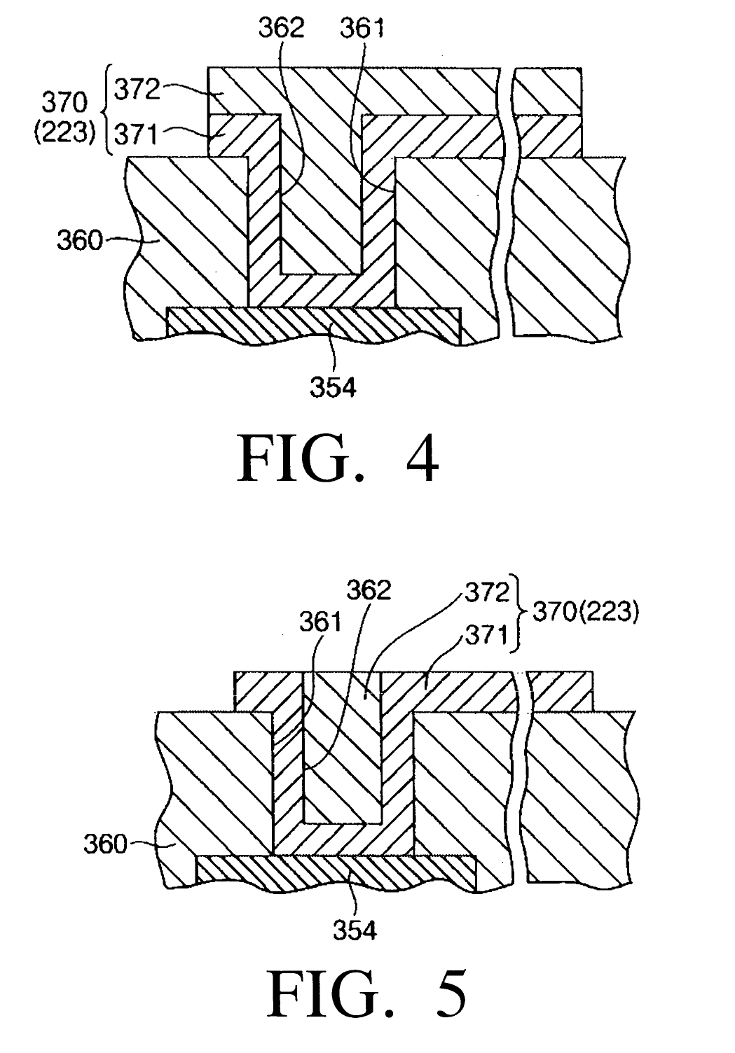

FIG. 2 is an exploded perspective view showing a transmissive liquid crystal display device 10 as a display device according to an embodiment of the present invention. FIG. 3 is an enlarged cross-sectional view showing a thin-film transistor 1 in the transmissive liquid crystal display device 10 shown in FIG. 2. FIG. 4 is an enlarged cross-sectional view showing an electrically connecting portion 370 formed on the thin-film transistor 1 shown in FIG. 3. In FIG. 2, some parts are not illustrated for the sake of simplification. In the following description, upper and lower sides in FIGS. 2, 3, and 4 will be referred to as “upper” and “lower,” respectively.

As shown in FIG. 2, the transmissive liquid crystal display device 10 has a liquid crystal panel (display panel) 20 and a backlight (light source) 60. Hereinafter, the transmissive liquid crystal display device 10 is simply referred to as the liquid crystal display device 10. The liquid crystal display device 10 has a function to display an image (information) by passing light from the backlight 60 through the liquid crystal panel 20.

The liquid crystal panel 20 has a first substrate 220 and a second substrate 230 opposed to each other. The liquid crystal panel 20 includes a sealing material (not shown) provided between the first substrate 220 and the second substrate 230 so as to surround a display area. The liquid crystal panel 20 also includes liquid crystals of electro-optic material within a space defined by the first substrate 220, the second substrate 230, and the sealing material. Thus, a liquid crystal layer (intermediate layer) 240 is formed in the liquid crystal panel 20. Specifically, the liquid crystal layer 240 is interposed between the first substrate 220 and the second substrate 230. Alignment layers (not shown) are formed on upper and lower surfaces of the liquid crystal layer 240, respectively. For example, the alignment layers may be made of polyimide or the like. The alignment layers serve to regulate orientations (alignment directions) of molecules of the liquid crystals forming the liquid crystal layer 240. For example, each of the first substrate 220 and the second substrate 230 may be made of various kinds of glasses, resins, or the like.

The first substrate 220 has a plurality of pixel electrodes 223 arranged in a matrix form, scanning lines 228 extending in an X direction, and signal lines 224 extending in a Y direction. The pixel electrodes 223, the scanning lines 228, and the signal lines 224 are formed on an upper surface 221 of the first substrate 220, which faces the liquid crystal layer 240. Each of the pixel electrodes 223 is formed of a transparent conductive film having a transmittance (light-transmittance) and connected to the signal line 224 and the scanning line 228 via one thin-film transistor 1 (switching device).

As shown in FIG. 3, the thin-film transistor 1 is provided on the first substrate 220. The thin-film transistor 1 has a semiconductor layer 314, a gate insulator 326, an insulating layer 342, and a gate electrode 351. The semiconductor layer 314 includes a channel region 320, a source region 316, and a drain region 318. The gate insulator 326 is formed so as to cover the semiconductor layer 314. The gate electrode 351 is formed so as to face the channel region 320 with interposing the gate insulator 326 between the gate electrode 351 and the channel region 320. The thin-film transistor 1 also has a conductive portion 356 formed on the insulating layer 342 so as to be positioned above the gate electrode 351, a conductive portion 352 formed on the insulating layer 342 so as to be positioned above the source region 316, and a conductive portion 354 formed on the insulating layer 342 so as to be positioned above the drain region 318. The conductive portion 352 serves as a source electrode, and the conductive portion 354 serves as a drain electrode. The thin-film transistor 1 includes a contact plug 355 for electrically connecting the gate electrode 351 and the conductive portion 356, a contact plug 350 for electrically connecting the source region 316 and the conductive portion 352, and a contact plug 353 for electrically connecting the drain region 318 and the conductive portion 354.

In the present embodiment, the semiconductor layer 314 is formed on the first substrate 220. For example, the semiconductor layer 314 may be made of silicon, such as polycrystalline silicon or amorphous silicon, or a semiconductor material, such as germanium or gallium arsenide. As described above, the semiconductor layer 314 includes the channel region 320, the source region 316, and the drain region 318. In the semiconductor layer 314, the source region 316 is formed on one side of the channel region 320, and the drain region 318 is formed on the other side of the channel region 320. For example, the channel region 320 may be made of an intrinsic semiconductor material. The source region 316 and the drain region 318 may be made of a semiconductor material doped with n-type impurities such as phosphorus. The semiconductor layer 314 is not limited to this example. For example, the source region 316 and the drain region 318 may be made of a semiconductor material doped with p-type impurities. The channel region 320 may be made of a semiconductor material doped with p-type or n-type impurities.

The semiconductor layer 314 is covered with insulating films (the gate insulator 326 and the insulating layer 342). A portion of the insulating films present between the channel region 320 and the gate electrode 351 serves as a gate insulator to provide a path of an electric field produced between the channel region 320 and the conductive portion 356.

Materials used for the gate insulator 326 and the insulating layer 342 are not limited to specific ones. For example, the gate insulator 326 and the insulating layer 342 may be made of a silicide such as SiO₂, TEOS (ethyl orthosilicate), or polysilazane. Alternatively, the gate insulator 326 and the insulating layer 342 may be made of resin or ceramic.

For example, the gate electrode 351 may be made of a conductive material such as indium tin oxide (ITO), indium oxide (IO), tin dioxide (SnO₂), antimony oxide (ATO), indium zinc oxide (IZO), Al, Al alloy, Cr, Mo, Ta, or Ta alloy.

The conductive portion 352, the conductive portion 354, and the conductive portion 356 are formed on the insulating layer 342 so as to be positioned above the source region 316, the drain region 318, and the channel region 320, respectively.

The gate insulator 326 and the insulating layer 342 have an opening (contact hole) formed in an area contacting the source region 316. This contact hole extends in a thickness direction of the gate insulator 326 and the insulating layer 342 so as to communicate with the source region 316. The contact plug 350 is formed within this contact hole. The conductive portion 352 is electrically connected to the source region 316 via the contact plug 350.

The gate insulator 326 and the insulating layer 342 also have an opening (contact hole) formed in an area contacting the drain region 318. This contact hole extends in the thickness direction of the gate insulator 326 and the insulating layer 342 so as to communicate with the drain region 318. The contact plug 353 is formed within this contact hole. The conductive portion 354 is electrically connected to the drain region 318 via the contact plug 353.

The insulating layer 342 has an opening formed in an area contacting the gate electrode 351. The opening extends in a thickness direction of the insulating layer 342 so as to communicate with the gate electrode 351. The contact plug 355 is formed within the opening. The conductive portion 356 is electrically connected to the gate electrode 351 via the contact plug 355.

The conductive portion 352 is electrically connected to the signal line 224, and the conductive portion 356 is electrically connected to the scanning line 228.

As shown in FIG. 2, an interlayer dielectric (passivation film) 360 is formed on the thin-film transistor 1 so as to cover the insulating layer 342, the conductive portion 352, the conductive portion 354, and the conductive portion 356. The interlayer dielectric 360 has a contact hole 361 extending in a thickness direction of the interlayer dielectric 360 so as to communicate with the conductive portion 354. The aforementioned materials for the gate insulator 326 and the insulating layer 342 can also be used for the interlayer dielectric 360.

As shown in FIG. 2, the liquid crystal display device 10 has a polarizer 225 provided on a lower surface of the first substrate 220. The liquid crystal display device 10 has a polarizer 235 provided on an upper surface of the second substrate 230. The polarizer 235 has a polarizing axis different from the polarizer 225.

The liquid crystal display device 10 also has a plurality of counter electrodes 232 formed on a lower surface 231 of the second substrate 230, which faces the liquid crystal layer 240. Each of the counter electrodes 232 is in the form of a strip. The counter electrodes 232 are disposed substantially in parallel to each other at predetermined intervals and arranged so as to face the pixel electrodes 223. A portion at which the counter electrode 232 overlaps the pixel electrodes 223 (and vicinity thereof) forms one pixel. The liquid crystals are activated at each pixel in the liquid crystal layer 240 so as to change its alignment state by charge or discharge between the electrodes. The counter electrodes 232 are made of a transparent conductive film having a transmittance (light-transmittance) as with the pixel electrodes 223.

The liquid crystal display device 10 has colored layers (color filters) 233 of red (R), green (G), and blue (B). The colored layers 233 are provided on lower surfaces of the counter electrodes 232. The colored layers 233 are divided by black matrices 234. The black matrices 234 have a shading function. For example, the black matrices 234 may be made of metal such as chromium, aluminum, aluminum alloy, nickel, zinc, or titanium, resin in which carbon is dispersed, or the like.

With the liquid crystal panel 20 thus constructed, light emitted from the backlight 60 is polarized by the polarizer 225 and then introduced through the first substrate 220 and the pixel electrodes 223 into the liquid crystal layer 240. The light introduced into the liquid crystal layer 240 is modulated in intensity by the liquid crystals having a controlled alignment state at each pixel. The light modulated in intensity passes through the colored layer 233, the counter electrodes 232, and the second substrate 230. Then, the light is polarized by the polarizer 235 and emitted to the exterior of the liquid crystal panel 20. Thus, for example, a (dynamic or static) color image including letters, numerals, and figures can be seen in a direction from the second substrate 230 to the liquid crystal layer 240 in the liquid crystal display device 10.

As shown in FIG. 2, an electrically connecting portion 370 is filled in the contact hole 361. The electrically connecting portion 370 is integrally formed on the interlayer dielectric 360 and electrically connected to the pixel electrode 223 formed on the interlayer dielectric 360.

In the present embodiment, the first substrate (base substrate) 220, the pixel electrodes 223, the signal lines 224, the scanning lines 228, the thin-film transistors 1, the interlayer dielectric 360, and the electrically connecting portions 370 form a substrate for an electronic device according to the present invention. Particularly, the electrically connecting portion 370 has the following features in a substrate for an electronic device according to the present invention.

As shown in FIG. 4, the electrically connecting portion 370 includes a conductive film 371 extending continuously to the pixel electrode 223 and a filler material 372 filled in a space 362 inside of the conductive film 371 within the contact hole 361. The conductive film 371 is formed on an inner surface of the contact hole 361 and a surface of the conductive portion (terminal) 354. The conductive film 371 is formed by a vapor phase process.

With the conductive film 371 thus constructed, the electrically connecting portion 370 has an excellent adhesiveness at a contact portion with the conductive portion 354 and also has an excellent electricity as compared to a case in which the electrically connecting portion 370 includes a conductive material formed at the connection with the conductive portion 354 by a liquid phase process. Accordingly, the liquid crystal display device 10 can have a high speed of response.

Further, since the filler material 372 is filled in the space 362, an upper surface of the electrically connecting portion 370 and an upper surface of the pixel electrode 223 can be formed by a continuous smooth surface. As a result, it is possible to reliably prevent recesses from being produced in a surface of an alignment layer, which is to be formed so as to cover the interlayer dielectric 360, the electrically connecting portion 370, and the pixel electrodes 223. Accordingly, fragments (broken pieces) of the alignment layer, which are produced by a rubbing process of the alignment layer, can effectively be prevented from remaining on the alignment layer. Thus, it is possible to reliably prevent deterioration of the orientation of the liquid crystal layer 240 and display unevenness of the liquid crystal display device 10.

Furthermore, since the filler material 372 is filled in the space 362, it is possible to effectively prevent separation from being caused at a contact portion between the conductive film 371 and the conductive portion 354 when an external stress is applied to the thin-film transistor 1.

The electrically connecting portion 370 can have any arrangement as long as the filler material 372 is filled in the space 362. In the example shown in FIG. 4, the filler material 372 is filled in the space 362 and supplied so as to cover an upper surface of the conductive film 371, i.e., a surface of the conductive film 371 which is opposite to the first substrate 220. Alternatively, as shown in FIG. 5, the filler material 372 may be supplied and filled into the space 362 in a manner such that the upper surface of the conductive film 371 is not covered by the filler material 372.

For example, the conductive film 371 may be made of a transparent conductive material, such as indium tin oxide (ITO), fluorinated indium tin oxide (FITO), antimony oxide (ATO), indium zinc oxide (IZO), aluminum zinc oxide (AZO), tin dioxide (SnO₂), zinc oxide (ZnO), fluorinated tin oxide (FTO), fluorinated indium oxide (FIO), or indium oxide (IO). Particularly, it is desirable that the conductive film 371 is made of indium oxide (ITO or FITO) containing at least one of Sn and F, tin dioxide (SnO₂) containing at least one of Sb, F, Nb, and Ta, or zinc oxide (ZnO) containing at least one of Al, Co, Fe, In, Sn, Ti, Ga, B, In, Y, Sc, F. V, Si, Ge, Zr, and Hf. When the conductive film 371 is made of a transparent conductive material mainly containing such a material, the conductive film 371 can have a high electrical conductivity and an excellent transparency. One of the aforementioned transparent materials may be used for the conductive film 371, or two or more types of the aforementioned transparent materials may be combined for the conductive film 371. When particles mainly made of indium oxide (ITO) containing Sn are employed in the transparent conductive material, it is desirable that an atomic ratio of indium and tin (indium/tin ratio) is in a range of 99/1 to 80/20, preferably 97/3 to 85/15. In such a case, the conductive film 371 can achieve the aforementioned effects more significantly.

The filler material 372 may be made of any of the transparent conductive materials described for the conductive film 371. Further, the filler material 372 may be made of a conductive material such as Al, Al alloy, Cr, Mo, Ta, or Ta alloy, a semiconductor material such as Si, Ge, silicon carbide (SiC), gallium nitride (GaN), or gallium arsenide (GaAs), or an insulating material such as silicon dioxide (SiO₂), hydrogen silsesquioxane (HSQ), methyl silsesquioxane (MSQ), silicon nitride (SiN), titanium nitride (TiN), polyimide resin, polyparaxylylene, benzocyclobutene, polyvinylphenol, novolac, polytetrafluoroethylene (PTFE), polymethylmethacrylate (PMMA), polyethylene, polypropylene, polyisobutylene, polybutene, or polyamide resin. One of these materials may be used for the filler material 372, or two or more types of these materials may be combined for the filler material 372.

In the first example of the electrically connecting portion 370 shown in FIG. 4, it is desirable that the filler material 372 is mainly made of a conductive material. The use of the filler material 372 mainly made of a conductive material can effectively inhibit or prevent the resistance of the pixel electrode 223 from being increased.

Further, when a transmissive liquid crystal display device as a display device according to the present invention includes the electrically connecting portions 370 of the first example shown in FIG. 4, it is desirable that the filler material 372 is mainly made of a transparent conductive material. The use of the filler material 372 mainly made of a transparent conductive material reliably allows the pixel electrode 223 to have a transmittance while it can effectively inhibit or prevent the resistance of the pixel electrode 223 from being increased. When a transmissive liquid crystal display device includes the electrically connecting portions 370 of the second example shown in FIG. 5, the filler material 372 may be made of a material other than a transparent material. Further, when the pixel electrodes 223 are not required to have a transmittance in other display devices, the conductive film 371 and the filler material 372 may either be made of a transparent material or a nontransparent material. Specifically, the conductive film 371 may be mainly made of any of the conductive materials described for the filler material 372. Such other display devices include electrophoresis display devices and organic electroluminescence elements in which emitted light is seen from counter electrodes facing pixel electrodes.

It is desirable that the pixel electrode 223 formed by the conductive film 371 and the filler material 372 has a surface resistance of 100 O/square or less, preferably 50 O/square or less. When the transparent conductive film has a surface resistance in such a range, the liquid crystal display device 10 can have a high speed of response.

2. Method of Manufacturing a Thin-Film Transistor

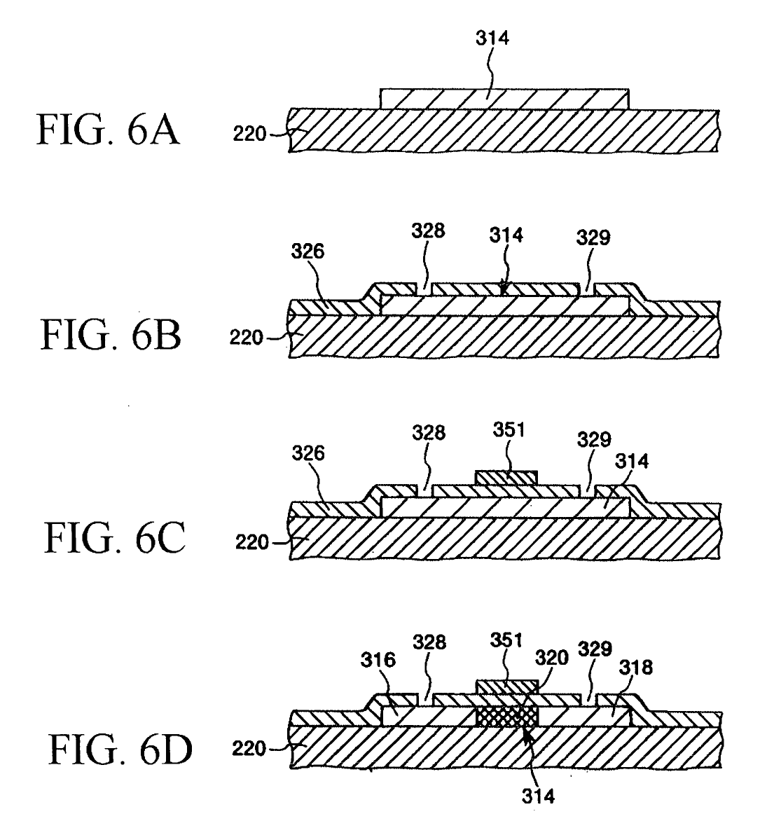

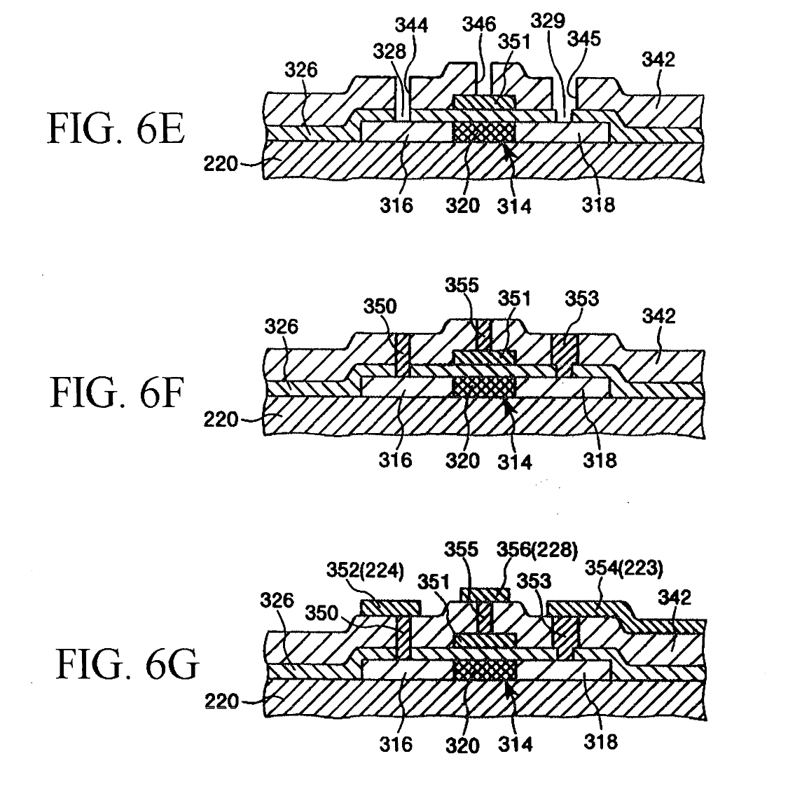

A specific example of a method of manufacturing a thin-film transistor (switching device) on a base substrate will be described below. FIGS. 6A through 6G are cross-sectional views showing an example of a method of forming a thin-film transistor according to a preferred embodiment of the present invention. In the following description, upper and lower sides in FIGS. 6A through 6G will be referred to as “upper” and “lower,” respectively.

Step I

First, as shown in FIG. 6A, a semiconductor layer (polycrystalline silicon film) 314 is formed on a first substrate (base substrate) 220. For example, the semiconductor layer 314 is formed as follows: A material for a resist layer is applied (or supplied) onto the first substrate 220. An opening is formed in a portion of the resist layer at which a semiconductor layer 314 is to be formed, by a photolithography method or the like. Then, a liquid material for forming a semiconductor layer is supplied to the opening by a coat method while the resist layer serves as a mask. Thereafter, a post-treatment process is performed to form the semiconductor layer 314 on the first substrate 220.

The resist layer can be formed by applying (or supplying) a resist material onto the first substrate 220, exposing the resist material to i-line, ultraviolet, electron beam, or the like with a photomask corresponding to a shape of a semiconductor layer 314 to be formed, and then developing the resist material. For example, the resist material can be applied onto the first substrate 220 by various application methods, such as an ink-jet method, a spin coat method, a casting method, a micro gravure coat method, a gravure coat method, a bar coat method, a roll coat method, a wire-bar coat method, a dip coat method, a spray coat method, a screen printing method, a flexographic printing method, an offset printing method, and a micro contact printing method. Two or more methods may be combined with each other. Either a negative resist or a positive resist may be used as a resist material. Examples of the negative resist include water soluble photoresists such as rosin-dichromate, polyvinyl alcohol (PVA)-dichromate, shellac-dichromate, casein-dichromate, PVA-diazo, and an acrylic photoresist, and oil soluble photoresists such as polyvinyl cinnamate, cyclized rubber-azide, polyvinyl cinnamylidene acetate, and polycinnamate β-vinyloxy ethylester. Examples of the positive resist include oil soluble photoresists such as O-naphthoquinone diazide.

For example, oxygen plasma or ozone vapor having an atmospheric pressure or a reduced pressure may be employed to remove the resist layer.

Further, when silicon hydride liquid is used as a material for the semiconductor layer, the following process may be performed to form a semiconductor layer (polycrystalline silicon film) 314 after silicon hydride liquid is supplied into the opening of the resist layer by a coat method.

First, the silicon hydride liquid supplied into the opening of the resist layer is dried. Then, the dried film is baked to pyrolyze silicon hydride into amorphous silicon. An excimer laser such as XeCl is applied to the amorphous silicon film to anneal the amorphous silicon film for polycrystallization. In this manner, the semiconductor layer (polycrystalline silicon film) 314 can be obtained. Thereafter, channel doping may be conducted on the semiconductor layer (polycrystalline silicon film) 314. Specifically, the semiconductor layer 314 may be doped with a predetermined amount of impurities on the entire surface of the semiconductor layer 314 so that the impurities are dispersed. For example, PH₃ ions may be used as impurities to form an n-type conductive layer.

Step II

Then, as shown in FIG. 6B, a gate insulator 326 having first contact holes 328 and 329 is formed on the first substrate 220 and the semiconductor layer 314. For example, the gate insulator 326 may be formed as follows: By a photolithography method or the like, a resist layer is formed on the semiconductor layer 314 at positions at which the first contact holes 328 and 329 are to be formed. Then, a liquid material for a gate insulator is supplied onto the first substrate 220 having the semiconductor layer 314 by a coat method while the resist layer is used as a mask. Thereafter, a post-treatment process is performed on the liquid material to form the gate insulator 326.

When the liquid material contains precursors of a material for the gate insulator 326, the precursors in the liquid material are changed into the gate insulator 326 by the post-treatment process to form the gate insulator 326. Post-treatment processes are not limited to specific ones. A suitable process is selected as a post-treatment process according to the types of the precursors. For example, examples of the post-treatment process include heating by a heater, an infrared lamp, laser irradiation, electromagnetic wave irradiation, and spike (FTP), and applying an ultraviolet ray. Prior to this process, at least a portion of a solvent or a dispersion medium used to prepare the material for a gate insulator may be removed. Specifically, precursors for a gate insulator mainly containing silicon dioxide include dichlorosilane, hexachlorodisilane, tetraethoxysilane, tetrakis (hydrocarbylamino) silane, tris(hydrocarbylamino) silane, and the like. Such precursors can be changed into silicon dioxide by heating in an oxidizing atmosphere.

Further, when the liquid material includes components for the gate insulator 326, a solvent or a dispersion medium in the liquid material may be removed. For example, examples of processes to remove a solvent or a dispersion medium include a vacuum drying process (under a reduced pressure) and a jetting process of inert gas in addition to the aforementioned heating processes.

Step III

Then, as shown in FIG. 6C, a gate electrode 351 is formed on the gate insulator 326 at a position corresponding to a channel region 320 to be formed. The gate electrode 351 can be formed in the same manner as described in Step I, for example, by a photolithography method using a resist layer which has an opening formed therein at a portion at which the gate electrode 351 is to be formed. For example, a liquid material mainly containing an organometallic compound may be used for formation of the gate electrode 351.

Step IV

While the gate electrode 351 is used as a mask, a source region 316 and a drain region 318 are doped with a predetermined amount of impurities. For example, when a p-type conductive layer is to be formed, B₂H₆ ions are used for the doping process. In this manner, as shown in FIG. 6D, a channel region 320 can be formed in the semiconductor layer 314 at a position below the gate electrode 351.

Step V

Then, as shown in FIG. 6E, an insulating film 342 having second contact holes 344, 345, and 346 is formed on the gate insulator 326. The second contact holes 344 and 345 communicate with the first contact holes 328 and 329 of the gate insulator 326, respectively. The insulating film 342 can be formed in the same manner as described in Step II, for example, by a photolithography method using a resist layer formed at positions at which the second contact holes 344, 345, and 346 are to be formed while the resist layer is used as a mask.

Step VI

As shown in FIG. 6F, contact plugs 350, 353, and 355 are formed so as to be filled in the first and second contact holes 328 and 344, the first and second contact holes 329 and 345, and the second contact hole 346, respectively. Thus, the contact plugs 350, 353, and 355 are electrically connected to the source region 316, the drain region 318, and the gate electrode 351, respectively.

The contact plugs 350, 353, and 355 are formed as follows: A conductive material is supplied onto the insulating film 342 so as to fill the contact holes 328, 329, 344, 345, and 346 and cover the insulating layer 342. Then, the conductive material is removed until an upper surface of the insulating layer 342 is exposed. Examples of a conductive material suitable for the contact plugs may include the materials described for the gate electrode 351. The supply of the conductive material may also be performed in the same manner as described for formation of the gate electrode 351. For example, the conductive material may be removed by at least one of physical etching methods such as plasma etching, reactive ions etching, beam etching, and photo-assisted etching, and chemical etching such as wet etching.

Step VII

Then, as shown in FIG. 6G, conductive portions 352, 354, and 356 are formed on the insulating film 342 so as to be electrically connected to the contact plugs 350, 353, and 355, respectively. The conductive portions 352, 354, and 356 can be formed in the same manner as described in Step I, for example, by a photolithography method using a resist layer which has openings formed therein at portions at which the conductive portions 352, 354, and 356 are to be formed. For example, a liquid material mainly containing an organometallic compound may be used for formation of the conductive portions 352, 354, and 356.

According to the above steps, a thin-film transistor 1 is formed on the first substrate 220.

3. Method of Manufacturing a Substrate for an Electronic Device

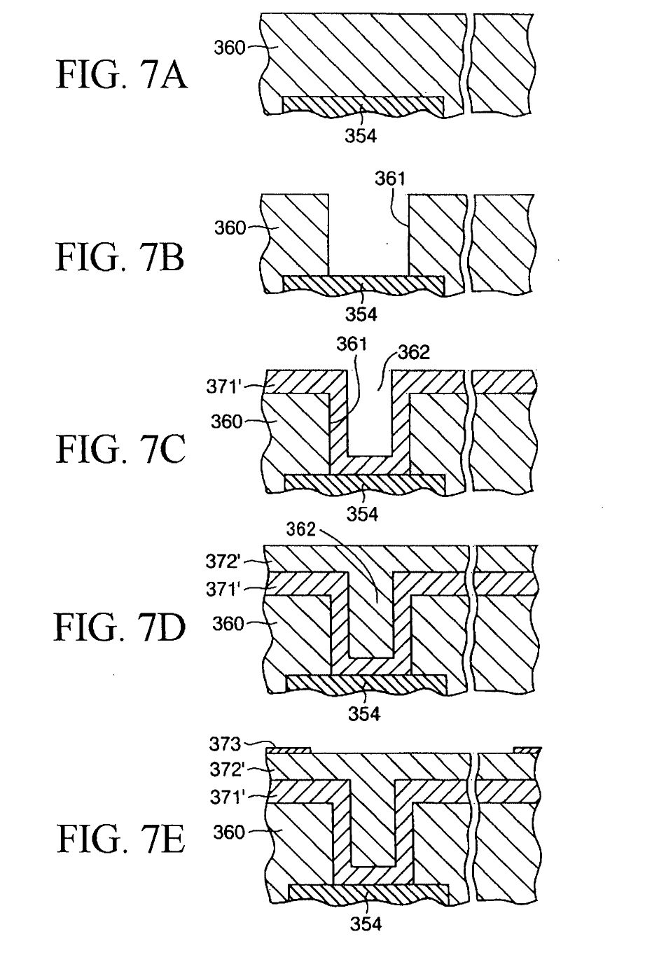

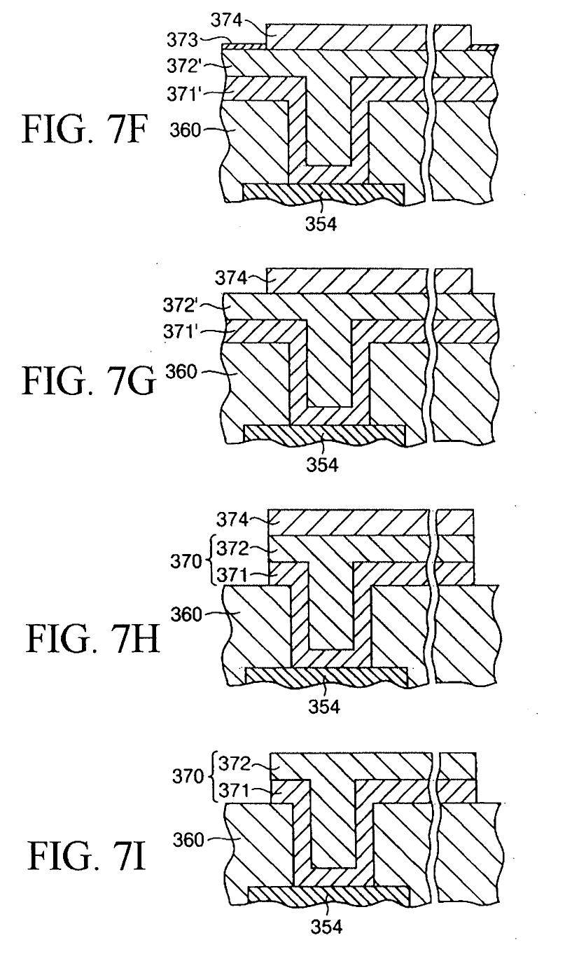

A substrate for an electronic device according to the present invention is manufactured with use of the aforementioned first substrate 220 having thin-film transistors 1. A method of manufacturing a substrate for an electronic device according to preferred embodiments of the present invention will be described below with reference to FIGS. 7A through 9K.

FIGS. 7A through 7I are schematic views (vertical cross-sectional views) explanatory of a method of manufacturing a substrate for an electronic device according to a first embodiment of the present invention. A method of manufacturing a substrate including an electrically connecting portion 370 of the first example shown in FIG. 4 will be described in the first embodiment. In the first embodiment, upper and lower sides in FIGS. 7A through 7I will be referred to as “upper” and “lower,” respectively.

As shown in FIGS. 7A through 7I, a method of manufacturing a substrate for an electronic device according to the first embodiment of the present invention includes preparation of a base substrate having a switching device and an interlayer dielectric (Step 1-A), formation of a contact hole in the interlayer dielectric (Step 1-B), supply of a conductive material by a vapor phase process for formation of a conductive material layer (Step 1-C), supply of a filler material by a liquid phase process for formation of a filler material layer (Step 1-D), liquid-repellent treatment for improving the liquid-repellency to a mask material (Step 1-E), formation of a mask in a formation area, in which a pixel electrode and an electrically connecting portion are to be formed (Step 1-F), removal of a portion subjected to the liquid-repellent treatment (Step 1-G), removal of unnecessary portions of the filler material layer and the conductive material layer (Step 1-H), and removal of the mask (Step 1-I). These steps will be described below.

Step 1-A. Preparation of a Base Substrate

First, a base substrate having a switching device and an interlayer dielectric 360 is prepared as shown in FIG. 7A. Such a substrate can be obtained as follows: A thin-film transistor 1 is formed on a first substrate (base substrate) 220 by the aforementioned method. Then, an interlayer dielectric 360 is formed so as to cover the thin-film transistor 1.

For example, the interlayer dielectric 360 is formed as follows: A material similar to a material for a gate insulator as described in Step II is supplied onto the thin-film transistor 1 by a coat method so as to cover the thin-film transistor 1. Then, a post-treatment process is performed. In this case, the coat methods and post-treatment processes described in Steps I and II can be employed to form the interlayer dielectric 360.

Step 1-B. Formation of a Contact Hole

Then, as shown in FIG. 7B, a contact hole 361 is formed in the interlayer dielectric 360 so as to extend in a thickness direction of the interlayer dielectric 360 to a conductive portion 354 (terminal of the switching device). Specifically, a surface of the conductive portion 354 is exposed by the contact hole 361.

For example, the contact hole 361 is formed as follows: By a photolithography method as described in Step I, a resist layer is formed on the interlayer dielectric 360 so as to have an opening at a position at which the contact hole 361 is to be formed. Then, while the resist layer is used as a mask, the interlayer dielectric 360 is etched so that a contact hole 361 is formed in the interlayer dielectric 360. In this case, at least one of physical etching methods and chemical etching methods described in Step VI can be employed to etch the interlayer dielectric 360.

Step 1-C. Formation of a Conductive Material Layer

Next, as shown in FIG. 7C, a conductive material is supplied by a vapor phase process to form a conductive material layer 371′ on the interlayer dielectric 360 in a region including a formation area, in which a pixel electrode 223 and an electrically connecting portion 370 are to be formed. The conductive material layer 371′ is formed on an inner surface of the contact hole 361 and a surface of the conductive portion 354 so as to have substantially the same thickness. As a result, a space 362 is formed inside of the conductive material layer 371′ within the contact hole 361.

Prior to formation of the conductive material layer 371′, an etching process may be performed on surfaces of the interlayer dielectric 360 and the conductive portion 354. For example, at least one of physical etching methods and chemical etching methods described in Step VI can be employed as the above etching process. With the etching process, the surfaces of the interlayer dielectric 360 and the conductive portion 354 can be hardened to improve adhesiveness to the conductive material layer 371′ to be formed. Further, it is possible to remove impurities such as an oxide film formed on the surface of the conductive portion 354 due to oxidation. Accordingly, it is possible to inhibit or prevent resistance from being increased at contact surfaces of the conductive portion 354 and the conductive material layer 371′.

The vapor phase process is not limited to a specific process. Examples of the vapor phase process include a physical vapor deposition process (PVD process) such as a sputtering method, a vacuum deposition method, an ion plating method, and a laser ablation method, a chemical deposition process such as a thermal CVD method, an MOCVD method, a laser CVD method, a plasma CVD method, and an atmospheric pressure CVD method, and a pyrosol method such as a liquid source misted chemical deposition method (LSMCD method), a spray pyrolysis deposition method (SPD method), and a metal-organic vapor phase epitaxy method (MOVPE method). When a physical vapor deposition process is performed as the vapor phase process, a transparent conductive material may be supplied to form a transparent conductive material layer 371′. When a chemical deposition process or a pyrosol method is performed as the vapor phase process, precursors of a transparent conductive material may be supplied to form a transparent conductive material layer 371′. Examples of such precursors of a transparent conductive material include an alkoxide and a salt of the transparent conductive material, and a derivative and a complex thereof. Examples of such an alkoxide include methoxide, ethoxide, propoxide, isopropoxide, and butoxide. Examples of such a salt include halide, formate, acetate, propionate, oxalate, and nitrate. Further, examples of such a derivative include hydrate and hydroxide produced by neutralization or hydrolysis. Examples of such a complex include chelate compounds of a-diketone, β-diketone, a-keto acid, β-keto acid, a-keto ester, β-keto ester, and aminoalcohol.

For example, a transparent conductive material mainly containing indium tin oxide (ITO) is supplied in the following manner using a sputtering method to form the conductive material layer 371′. The base substrate 220, which has the thin-film transistor 1 and the interlayer dielectric 360 formed thereon, and a target of ITO are disposed (set) in a chamber. Then, an ion beam is applied to the target. When the ion beam hits a surface of the target, particles (sputter particles) of ITO are sputtered and attached to the region including the formation area to form the conductive material layer 371′.

Step 1-D. Formation of a Filler Material Layer

Subsequently, a filler material is supplied onto the conductive material layer 371′ by a liquid phase process to form a filler material layer 372′. Thus, as shown in FIG. 7D, an upper surface of the conductive material layer 371′ is covered with the filler material layer 372′, and the space 362 is filled with the filler material layer 372′. In the present embodiment, since a filler material is supplied by a liquid phase process, the filler material layer 372′ can be filled into the space 362 with ease and reliability.

Specifically, the following process is performed in Step 1-D.

First, a liquid material containing a filler material or precursors thereof is prepared. Examples of such precursors of the filler material include an alkoxide and a salt of the filler material, and a derivative and a complex thereof. The examples of an alkoxide, a salt, a derivative, and a complex described in Step 1-C can also be employed for the filler material. For example, when an alkoxide or a salt is used as precursors of the filler material, it is desirable to add an acid catalyst or a base catalyst to promote change (transformation) of precursors into the filler material. Examples of such an acid catalyst include inorganic acid such as hydrochloric acid, nitric acid, boric acid, and fluoroboric acid, and organic acid such as acetic acid, trifluoroacetic acid, and p-toluenesulfonic acid.

Examples of a solvent or a dispersion medium used for preparation of the liquid material include inorganic solvents such as nitric acid, sulfuric acid, ammonia, hydrogen peroxide, water, carbon disulfide, carbon tetrachloride, and ethylene carbonate, ketone solvents such as methyl ethyl ketone (MEK), acetone, diethyl ketone, methyl isobutyl ketone (MIBK), methyl isopropyl ketone (MIPK), and cyclohexanone, alcohol solvents such as methanol, ethanol, isopropanol, ethylene glycol, diethylene glycol (DEG), and glycerin, ether solvents such as diethyl ether, diisopropyl ether, 1,2-dimethoxyethane (DME), 1,4-dioxane, tetrahydrofuran (THF), tetrahydropyran (THP), anisole, diethylene glycol dimethyl ether (diglyme), and diethylene glycol ethyl ether (Carbitol™), cellosolve solvents such as methyl cellosolve, ethyl cellosolve, and phenyl cellosolve, aliphatic hydrocarbon solvents such as hexane, pentane, heptane, and cyclohexane, aromatic hydrocarbon solvents such as toluene, xylene, benzene, trimethylbenzene, and tetramethylbenzene, heteroaromatic compound solvents such as pyridine, pyrazine, furan, pyrrole, thiophene, and methylpyrrolidone, amide solvents such as N,N-dimethylformamide (DMF), and N,N-dimethylacetamide (DMA), halogen compound solvents such as dichloromethane, chloroform, and 1,2-dichloroethane, ester solvents ethyl acetate, methyl acetate, and ethyl formate, sulfur compound solvents such as dimethyl sulfoxide (DMSO), and sulfolane, nitrile solvents such as acetonitrile, propionitrile, and acrylonitrile various organic solvents including organic acid solvents such as formic acid, acetic acid, trichloroacetic acid, and trifluoroacetic acid, and mixed solvents thereof.

Then, the liquid material thus prepared is supplied onto the conductive material layer 371′ by the liquid phase process. For example, at least one of the coat methods described in Step I may be employed as the liquid phase process. Thereafter, a post-treatment process is performed on the liquid material to form the filler material layer 372′ on the conductive material layer 371′. Examples of the post-treatment process include the post-treatment processes described in Step II.

Step 1-E. Liquid-Repellent Treatment

Next, in order to improve the liquid-repellency to a mask material used in next Step 1-F, liquid-repellent treatment is performed on an upper surface of the filler material layer 372′ in a region excluding the formation area, in which a pixel electrode 223 and an electrically connecting portion 370 are to be formed. The liquid-repellent treatment allows a mask 374 to be formed selectively in the formation area in next Step 1-F.

The liquid-repellent treatment may be performed by one or two methods including forming a liquid-repellent film on the upper surface of the filler material layer 372′ in the region excluding the formation area and injecting (applying) ions capable of proving the liquid-repellency, such as fluoride ions, to the upper surface of the filler material layer 372′ in the region excluding the formation area. As shown in FIG. 7E, it is desirable that the liquid-repellent treatment is performed by forming a liquid-repellent film 373 on the upper surface of the filler material layer 372′ in the region excluding the formation area. With this method, the liquid-repellency can relatively readily be provided on the upper surface of the filler material layer 372′ in the region excluding the formation area.

For example, the liquid-repellent film 373 can be formed by supplying a material for a liquid-repellent film on the filler material layer 372′ and drying the material as needed. In this case, the liquid-repellent film 373 may be formed so as to cover the entire upper surface of the filler material layer 372′ and then removed at unnecessary portions. However, it is desirable that the liquid-repellent film 373 is formed selectively in the region excluding the formation area.

Examples of a method of forming the liquid-repellent film 373 selectively in the region excluding the formation area include the following methods (1) to (3).

(1) A resist layer is formed on the formation area by a photolithography method. Then, the resist layer is used as a mask.

(2) A stamper having a shape corresponding to the region excluding the formation area is brought into contact with the upper surface of the filler material layer 372′ while the filler material layer 372′ is immersed in a material for a liquid-repellent film.

(3) A material for a liquid-repellent film is ejected to the region excluding the formation area by an ink-jet method.

Among the above methods (1) to (3), it is desirable to use the method (3) employing an ink-jet method. With the method (3), the liquid-repellent film 373 can be formed selectively in the region excluding the formation area with ease and reliability.

Examples of the liquid-repellent film 373 include a self-assembled monolayer film (SAM film) of a coupling agent having a functional group capable of providing liquid-repellency or alkanethiol, and a polymerized film of liquid-repellent resin. The material for the liquid-repellent film 373 may be prepared by mixing a material of the liquid-repellent film 373 and/or precursors thereof into a solvent or a dispersion medium. Examples of the coupling agent include a silane coupling agent, a titanium coupling agent, an aluminum coupling agent, a zirconium coupling agent, an organic phosphate coupling agent, and a xylyl peroxide coupling agent. Specific examples of the coupling agent include tridecafluoro-1,1,2,2-tetrahydrooctyltriethoxysilane, tridecafluoro-1,1,2,2-tetrahydrooctyltrimethoxysilane, trichloroalkylsilane (FAS), octadecyltrimethoxysilane, and vinyltrimethoxysilane. Examples of the functional group capable of providing liquid-repellency include a fluoroalkyl group, an alkyl group, a vinyl group, an epoxy group, a styryl group, and a methacryloxy group. Examples of the liquid-repellent resin include fluororesin such as polytetrafluoroethylene (PTFE), tetrafluoroethylene-perfluoroalkylvinylether copolymer (PFA), ethylene-tetrafluoroethylene copolymer (ETFE), perfluoroethylene-propene copolymer (FEP), and ethylene-chlorotrifluoroethylene copolymer (ECTFE). Further, the solvents or dispersion media described in Step 1-D can also be used as the solvent or the dispersion medium in Step 1-E.

Step 1-F. Formation of a Mask

Then, as shown in FIG. 7F, a mask material is supplied by a liquid phase process to form a mask 374 on the upper surface of the filler material layer 372′ in the formation area, in which a pixel electrode 223 and an electrically connecting portion 370 are to be formed. Thus, the mask 374 has a shape corresponding to the formation area. This step can be performed with a liquid mask material containing thermosetting resin, thermoplastic resin, and/or precursors thereof in the same manner as described in Step 1-D.

In the present embodiment, since the liquid-repellent film 373 has been formed in the region excluding the formation area in Step 1-E, the mask 374 can be formed selectively in the formation area.

When a resist material described in Step I is used as the mask material, Step 1-E can be eliminated. In this case, after a resist layer is formed on the entire surface of the filler material layer 372′, the resist layer is removed in the region excluding the formation area by a photolithography method. As a result, a mask 374 (resist layer) having a shape corresponding to the formation area can be formed on the filler material layer 372′.

Step 1-G. Removal of the Liquid-Repellent Film

Subsequently, as shown in FIG. 7G, the liquid-repellent film 373, which has been formed in the region excluding the formation area, is removed from the surface of the filler material layer 372′. Physical etching methods or chemical etching methods described in Step VI can also be used to remove the liquid-repellent film 373. Further, a method of irradiating an ultraviolet ray or a method of spraying water vapor may be used to remove the liquid-repellent film 373. At least two of these methods may also be combined with each other.

Step 1-H. Removal of Unnecessary Portions

Next, as shown in FIG. 7H, unnecessary portions of the filler material layer 372′ and the conductive material layer 371′ are collectively removed in the region excluding the formation area with use of the mask 374 formed in the formation area. Physical etching methods or chemical etching methods described in Step VI can be used to remove the unnecessary portions of the filler material layer 372′ and the conductive material layer 371′. At least two of these methods may also be combined with each other.

Step 1-I. Removal of the Mask

Then, as shown in FIG. 7I, the mask 374, which has been formed in the formation area, is removed from the surface of the filler material 372. Physical etching methods or chemical etching methods described in Step VI can be used to remove the mask 374. At least two of these methods may also be combined with each other.

Steps 1-G, 1-H, and 1-I may collectively be performed. Specifically, the liquid-repellent film 373 and unnecessary portions of the filler material layer 372′ and the conductive material layer 371′ may be removed simultaneously, and the mask 374 may subsequently be removed.

According to the above steps, it is possible to form an electrically connecting portion 370 of the first example shown in FIG. 4 and a pixel electrode 223. Thus, a substrate for an electronic device according to the present invention can be manufactured.

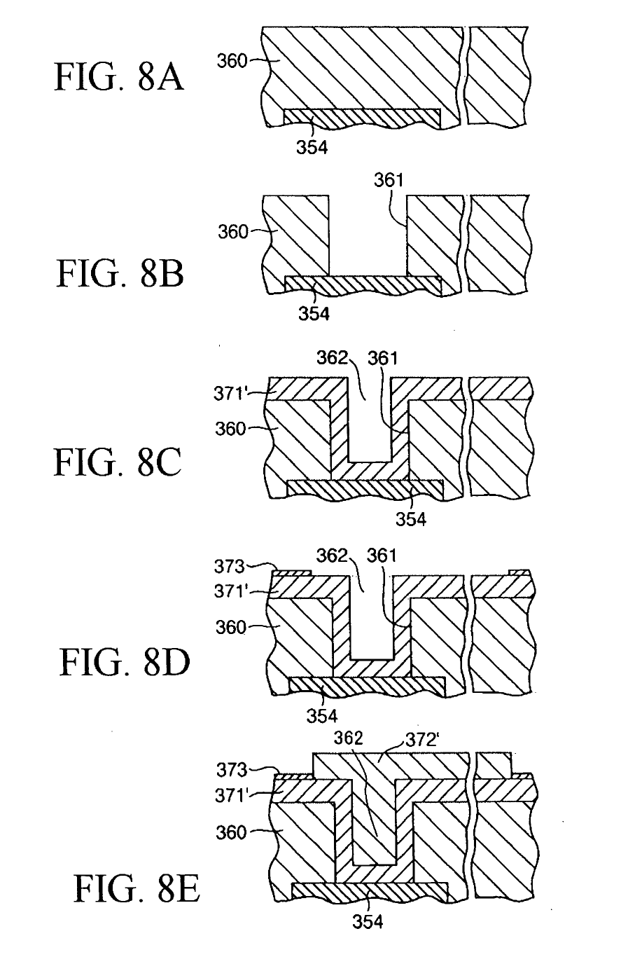

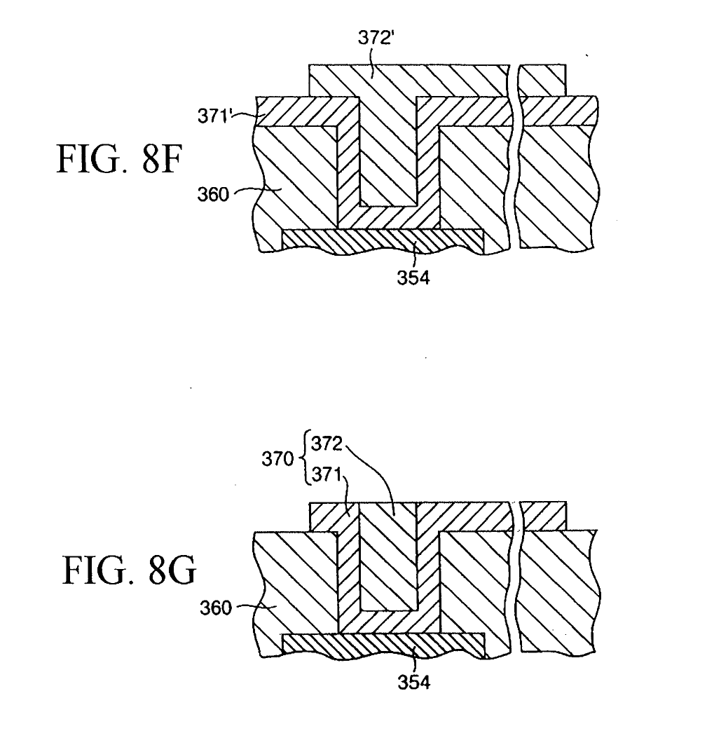

FIGS. 8A through 8G are schematic views (vertical cross-sectional views) explanatory of a method of manufacturing a substrate for an electronic device according to a second embodiment of the present invention. A method of manufacturing a substrate including an electrically connecting portion 370 of the second example shown in FIG. 5 will be described in the second embodiment. In the second embodiment, upper and lower sides in FIGS. 8A through 8G will be referred to as “upper” and “lower,” respectively.

As shown in FIGS. 8A through 8G, a method of manufacturing a substrate for an electronic device according to the second embodiment of the present invention includes preparation of a base substrate having a switching device and an interlayer dielectric (Step 2-A), formation of a contact hole in the interlayer dielectric (Step 2-B), supply of a conductive material by a vapor phase process for formation of a conductive material layer (Step 2-C), liquid-repellent treatment for improving the liquid-repellency to a liquid material (Step 2-D), supply of a filler material by a liquid phase process for formation of a filler material layer (Step 2-E), removal of a portion subjected to the liquid-repellent treatment (Step 2-F), and removal of an unnecessary portion of the conductive material layer and a portion of the filler material layer (Step 2-G). These steps will be described below.

Step 2-A. Preparation of a Substrate

First, a base substrate having a thin-film transistor 1 and an interlayer dielectric 360 is prepared as shown in FIG. 8A. The interlayer dielectric 360 can be formed in the same manner as descried in Step 1-A.

Step 2-B. Formation of a Contact Hole

Then, as shown in FIG. 8B, a contact hole 361 is formed in the interlayer dielectric 360 so as to extend in a thickness direction of the interlayer dielectric 360 to a conductive portion 354 (terminal of the switching device). The contact hole 361 can be formed in the same manner as descried in Step 1-B.

Step 2-C. Formation of a Conductive Material Layer

Next, as shown in FIG. 8C, a transparent conductive material is supplied by a vapor phase process to form a conductive material layer 371′ on the interlayer dielectric 360 in a region including a formation area. The conductive material layer 371′ can be formed in the same manner as descried in Step 1-C.

Step 2-D. Liquid-Repellent Treatment

Subsequently, in order to improve the liquid-repellency to a liquid material used in next Step 2-E, liquid-repellent treatment is performed on an upper surface of the conductive material layer 371′ in a region excluding the formation area. Thus, as shown in FIG. 8D, a liquid-repellent film 373 is formed in the region excluding the formation area. The liquid-repellent treatment allows a filler material layer 372′ to be formed selectively in the formation area in next Step 2-E. The liquid-repellent film 373 can be formed in the same manner as descried in Step 1-E. Alternatively, the liquid-repellent film 373 may be formed in the following manner.

First, a resist layer is formed on the upper surface of the conductive material layer 371′ in the region excluding the formation area. For example, the resist layer can be formed in the same manner as described in Step I. Then, hydrophilic treatment is performed on the entire surface of the resist layer. Examples of the hydrophilic treatment include an irradiation method of irradiating an ultraviolet ray and/or an infrared ray in an atmosphere containing oxygen and an oxygen plasma method of applying oxygen plasma. Particularly, it is preferable to employ an oxygen plasma method. According to an oxygen plasma method, a gas containing oxygen is introduced into a discharge area to generate oxygen plasma, which is applied to the entire surface of the resist layer to provide the hydrophilicity to the resist layer. Such an oxygen plasma method can provide the hydrophilicity to the entire surface of the resist layer with ease and reliability. Typically, pure oxygen gas can be used as a gas containing oxygen. However, it is desirable to use a mixed gas of oxygen gas and fluorocarbon gas (e.g., tetrafluoromethane gas). The use of such a mixed gas prolongs a period of time for which oxygen plasma is maintained. Accordingly, it is possible to apply the maintained oxygen plasma reliably to the resist layer.

Then, liquid-repellent treatment is performed on an upper surface of the resist layer, which has been subjected to the hydrophilic treatment. With such liquid-repellent treatment of the resist layer, it is possible to form a liquid-repellent film 373 having side surfaces subjected to the hydrophilic treatment and an upper surface subjected to the liquid-repellent treatment. Thus, a filler material is prevented from being attached to the liquid-repellent film in next Step 2-E but can be supplied to the formation area reliably. Examples of the liquid-repellent treatment include a fluorine plasma method of applying fluorine plasma to the upper surface of the resist layer. According to a fluorine plasma method, a gas containing fluorine is introduced into a discharge area to generate fluorine plasma, which is applied to the upper surface of the resist layer to provide the liquid-repellency to an area to which the fluorine plasma is applied. Such a fluorine plasma method can fluoridate substantially the entire upper surface of the resist layer uniformly. Specifically, the liquid-repellency can uniformly be provided to the upper surface of the resist layer (without unevenness). Examples of the gas containing fluorine atoms include tetrafluoromethane(CF₄), tetrafluoroethylene(C₂F₄), hexafluoropropylene(C₃F₆), and octafluorobutylene(C₄F₈). Particularly, it is preferable to use a gas mainly containing tetrafluoromethane.

The aforementioned hydrophilic treatment and/or liquid-repellent treatment may be eliminated when the resist layer has hydrophilicity or liquid-repellency.

Step 2-E. Formation of a Filler Material Layer

Next, as shown in FIG. 8E, a filler material is supplied onto the conductive material layer 371′ at a position corresponding to the formation area by a liquid phase process to form a filler material layer 372′ on the conductive material layer 371′. Thus, the upper surface of the conductive material layer 371′ can be covered with the filler material in the formation area, and the space 362 can be filled with the filler material. In the present embodiment, since the liquid-repellent film 373 is formed in the region excluding the formation area in Step 2-D, the filler material layer 372′ can be formed selectively in the formation area. The filler material layer 372′ can be formed in the same manner as described in Step 1-D.

Step 2-F. Removal of the Liquid-Repellent Film

Then, as shown in FIG. 8F, the liquid-repellent film 373, which has been formed in the region excluding the formation area, is removed from the upper surface of the conductive material layer 371′. The liquid-repellent film 373 can be removed in the same manner as descried in Step 1-G.

Step 2-G. Removal of Unnecessary Portions

Next, unnecessary portions of the conductive material layer 371′ are removed from the upper surface of the interlayer dielectric 360 while the filler material layer 372′ is used as a mask. Then, an unnecessary portion of the filler material layer 372′ is removed from the upper surface of the conductive material layer 371′. Thus, as shown in FIG. 8G, it is possible to obtain a conductive film 371 having a shape corresponding to the shape of the formation area. Further, it is possible to maintain a filler material 372 filled in the space 362 while the portion of the filler material layer 372′, which has been supplied on the upper surface of the conductive material layer 371′ in the formation area, is removed. The unnecessary portions can be removed in the same manner as described in Step 1-H.

Steps 2-F and 2-G may collectively be performed. Specifically, removal of the liquid-repellent film 373 and removal of unnecessary portions of the conductive material layer 371′ may be performed simultaneously.

According to the above steps, it is possible to form an electrically connecting portion 370 of the second example shown in FIG. 5 and a pixel electrode 223. Thus, a substrate for an electronic device according to the present invention can be manufactured.

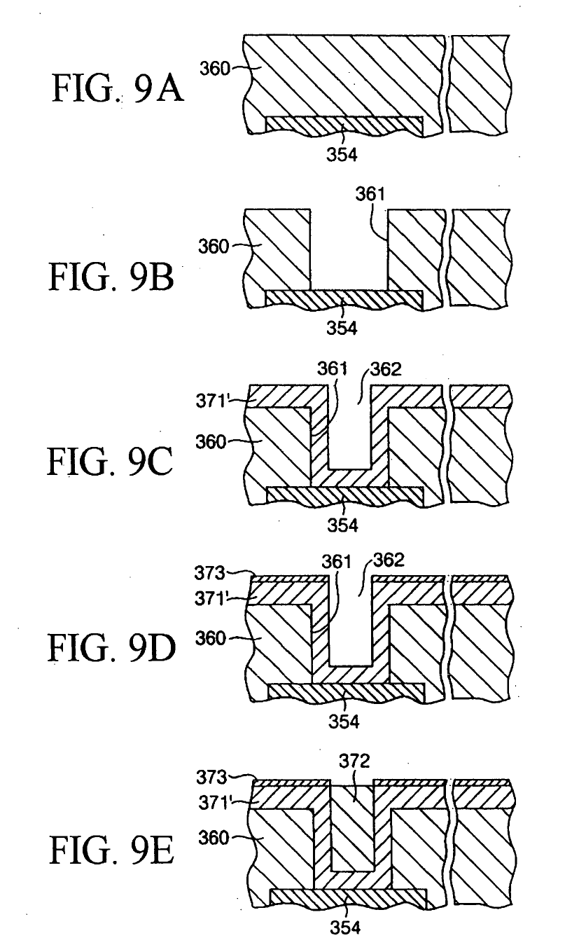

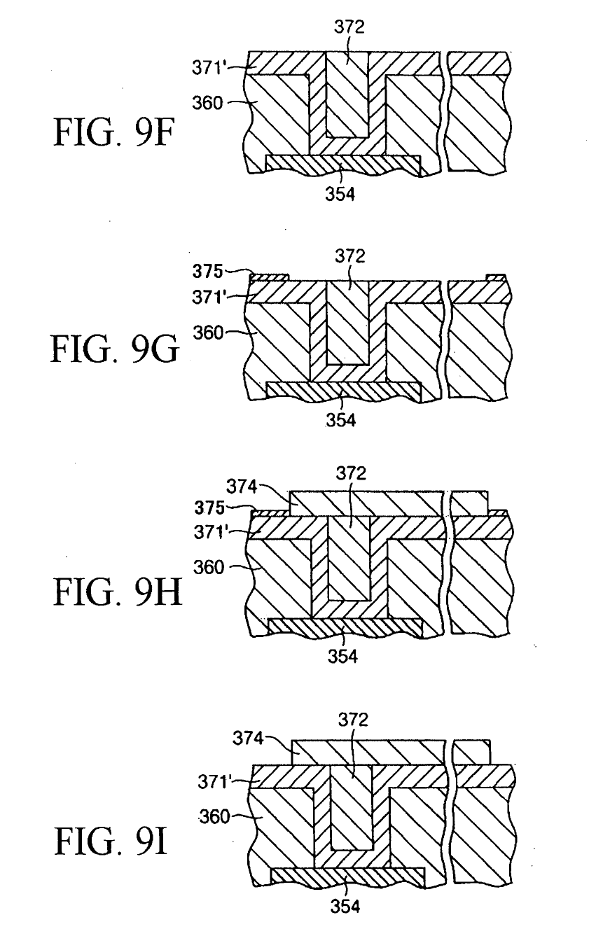

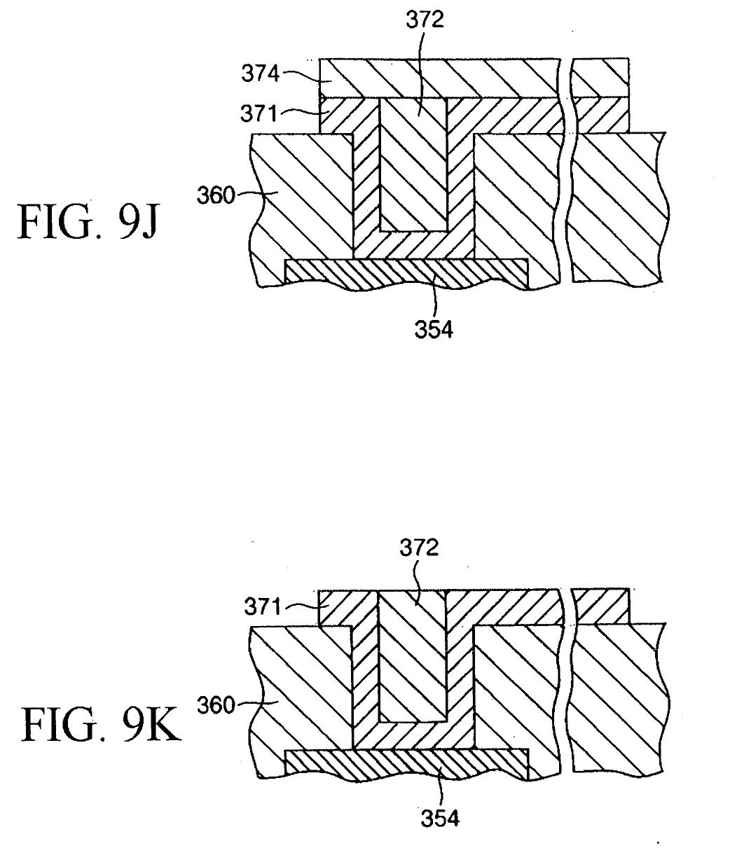

FIGS. 9A through 9K are schematic views (vertical cross-sectional views) explanatory of a method of manufacturing a substrate for an electronic device according to a third embodiment of the present invention. A method of manufacturing a substrate including an electrically connecting portion 370 of the second example shown in FIG. 5 will be described in the third embodiment. In the third embodiment, upper and lower sides in FIGS. 9A through 9K will be referred to as “upper” and “lower,” respectively.

As shown in FIGS. 9A through 9K, a method of manufacturing a substrate for an electronic device according to the third embodiment of the present invention includes preparation of a base substrate having a switching device and an interlayer dielectric (Step 3-A), formation of a contact hole in the interlayer dielectric (Step 3-B), supply of a conductive material by a vapor phase process for formation of a conductive material layer (Step 3-C), liquid-repellent treatment for improving the liquid-repellency to a liquid material (Step 3-D), supply of a filler material by a liquid phase process for filling a filler material (Step 3-E), removal of a portion subjected to the liquid-repellent treatment (Step 3-F), liquid-repellent treatment for improving the liquid-repellency to a mask material (Step 3-G), formation of a mask in a formation area, in which a pixel electrode and an electrically connecting portion is to be formed (Step 3-H), removal of the portion subjected to the liquid-repellent treatment (Step 3-I), removal of an unnecessary portion of the conductive material layer (Step 3-J), and removal of the mask (Step 3-K). These steps will be described below.

Step 3-A. Preparation of a Substrate

First, a substrate having a thin-film transistor 1 and an interlayer dielectric 360 is prepared as shown in FIG. 9A. The interlayer dielectric 360 can be formed in the same manner as descried in Step 1-A.

Step 3-B. Formation of a Contact Hole

Then, as shown in FIG. 9B, a contact hole 361 is formed in the interlayer dielectric 360 so as to extend in a thickness direction of the interlayer dielectric 360 to a conductive portion 354 (terminal of the switching device). The contact hole 361 can be formed in the same manner as descried in Step 1-B.

Step 3-C. Formation of a Conductive Material Layer

Next, as shown in FIG. 9C, a transparent conductive material is supplied to a region including a formation area by a vapor phase process to form a conductive material layer 371′ on the interlayer dielectric 360. The conductive material layer 371′ can be formed in the same manner as descried in Step 1-C.

Step 3-D. Liquid-Repellent Treatment

Subsequently, in order to improve the liquid-repellency to a liquid material used in next Step 3-E, liquid-repellent treatment is performed on an upper surface of the conductive material layer 371′ in a region excluding a surface of the conductive material layer 371′ within the space 362. The liquid-repellent treatment allows a filler material 372 to be formed selectively within the space 362 in next Step 3-E. Thus, as shown in FIG. 9D, a liquid-repellent film 373 can be formed in the same manner as descried in Step 2-D.

Step 3-E. Filling of a Filler Material

Then, as shown in FIG. 9E, a filler material 372 is filled selectively in the space 362 by a liquid phase process. In the present embodiment, since the liquid-repellent film 373 has been formed on the upper surface of the conductive material layer 371′ in Step 3-D, the filler material 372 can be filled selectively in the space 362. The filler material 372 can be filled in the same manner as described in Step 1-D. The liquid-repellent treatment in Step 3-D may be eliminated if the liquid phase process of Step 3-E employs a method that can supply a filler material 372 selectively in the space 362, such as an ink-jet method.

Step 3-F. Removal of the Liquid-Repellent Film

Then, as shown in FIG. 9F, the liquid-repellent film 373, which has been formed on the upper surface of the conductive material layer 371′, is removed from the upper surface of the conductive material layer 371′. The liquid-repellent film 373 can be removed in the same manner as descried in Step 1-G.

Step 3-G. Liquid-Repellent Treatment

Next, in order to improve the liquid-repellency to a mask material used in next Step 3-H, liquid-repellent treatment is performed on an upper surface of the conductive material layer 371′ in the region excluding the formation area, in which a pixel electrode 223 and an electrically connecting portion 370 are to be formed. Thus, as shown in FIG. 9G, a liquid-repellent film 375 is formed in the region excluding the formation area. The liquid-repellent treatment allows a mask 374 to be formed selectively in the formation area in next Step 3-H. The liquid-repellent film 375 can be formed in the same manner as descried in Step 1-E. In Step 3G, liquid-repellent treatment may be performed in the region excluding the formation area to form the liquid-repellent film 375 as described above, or a portion of the liquid-repellent film 373 formed in Step 3-D may be removed to form the liquid-repellent film 375. In the case where a portion of the liquid-repellent film 373 formed in Step 3-D is removed, the aforementioned step for removal of the liquid-repellent film 373 (Step 3-F) can be eliminated.

Step 3-H. Formation of a Mask

Subsequently, as shown in FIG. 9H, a mask material is supplied by a liquid phase process to form a mask 374 on the upper surface of the conductive material layer 371′ in the formation area. The mask 374 can be formed in the same manner as described in Step 1-F. In the present embodiment, since the liquid-repellent film 375 has been formed on the upper surface of the conductive material layer 371′ in the region excluding the formation area in Step 3-G, the mask 374 can be formed selectively in the formation area.

Step 3-I. Removal of the Liquid-Repellent Film

Then, as shown in FIG. 9I, the liquid-repellent film 375, which has been formed on the upper surface of the conductive material layer 371′, is removed from the upper surface of the conductive material layer 371′. The liquid-repellent film 375 can be removed in the same manner as descried in Step 1-G.

Step 3-J. Removal of Unnecessary Portions

Next, as shown in FIG. 9J, unnecessary portions of the conductive material layer 371′ are removed from the upper surface of the interlayer dielectric 360 in the region excluding the formation area with use of the mask 374 formed in the formation area. The unnecessary portions of the conductive material layer 371′ can be removed in the same manner as described in Step 1-H.

Step 3-K. Removal of the Mask

Next, as shown in FIG. 9K, the mask 374, which has been formed in the formation area, is removed from the upper surfaces of the conductive film 371 and the filler material 372. The mask 374 can be removed in the same manner as described in Step 1-I.

Step 3-I, 3-J, and 3-K may collectively be performed. Specifically, the liquid-repellent film 373 and unnecessary portions of the conductive material layer 371′ may be removed simultaneously, and the mask 374 may subsequently be removed.

According to the above steps, it is possible to form an electrically connecting portion 370 of the second example shown in FIG. 5 and a pixel electrode 223. Thus, a substrate for an electronic device according to the present invention can be manufactured.

According to a method of manufacturing a substrate for an electronic device as described in the first, second, and third embodiments, an electrically connecting portion 370 and a pixel electrode 223 are produced by using a vapor phase process and a liquid phase process. Therefore, the film thickness of the electrically connecting portion 370 and the pixel electrodes 223 can be controlled with ease.

4. Electronic Devices

A display device according to the present invention can be used in various electronic devices.

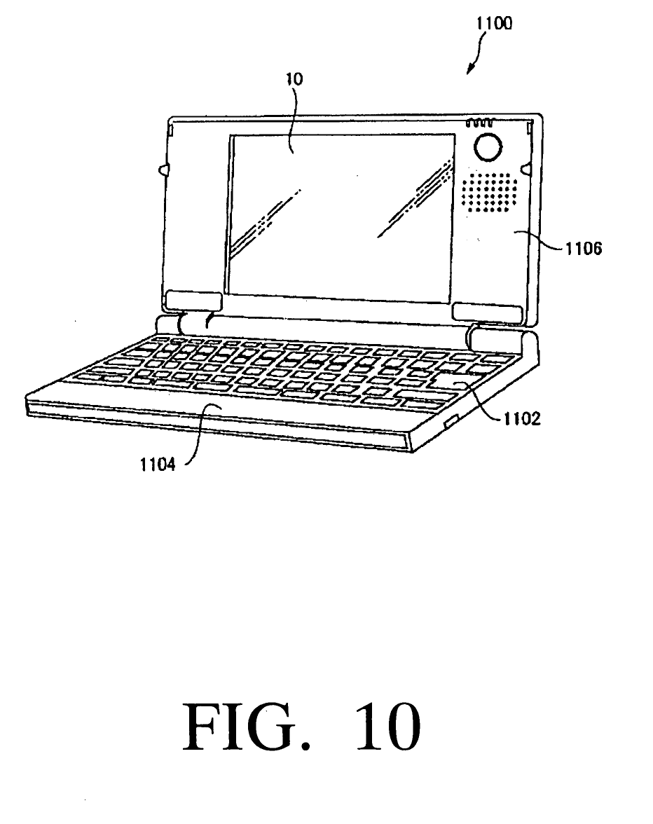

FIG. 10 is a perspective view showing a portable (or notebook) personal computer 1100 having an electronic device according to the present invention. In FIG. 10, the personal computer 1100 includes a body 1104 having a keyboard 1102 and a display unit 1106. The display unit 1106 is rotatably supported on the body 1104 by a hinge structure. In the personal computer 1100, the display unit 1106 includes the aforementioned liquid crystal display device (electro-optical device) 10.

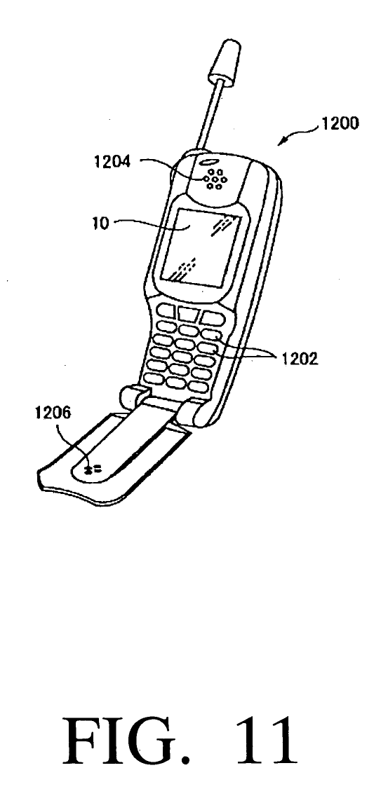

FIG. 11 is a perspective view showing a cellular phone 1200 (including PHS) having an electronic device according to the present invention. In FIG. 11, the cellular phone 1200 includes a plurality of operation buttons 1202, an earpiece 1204, a mouthpiece 1206, and the aforementioned liquid crystal display device (electro-optical device) 10.

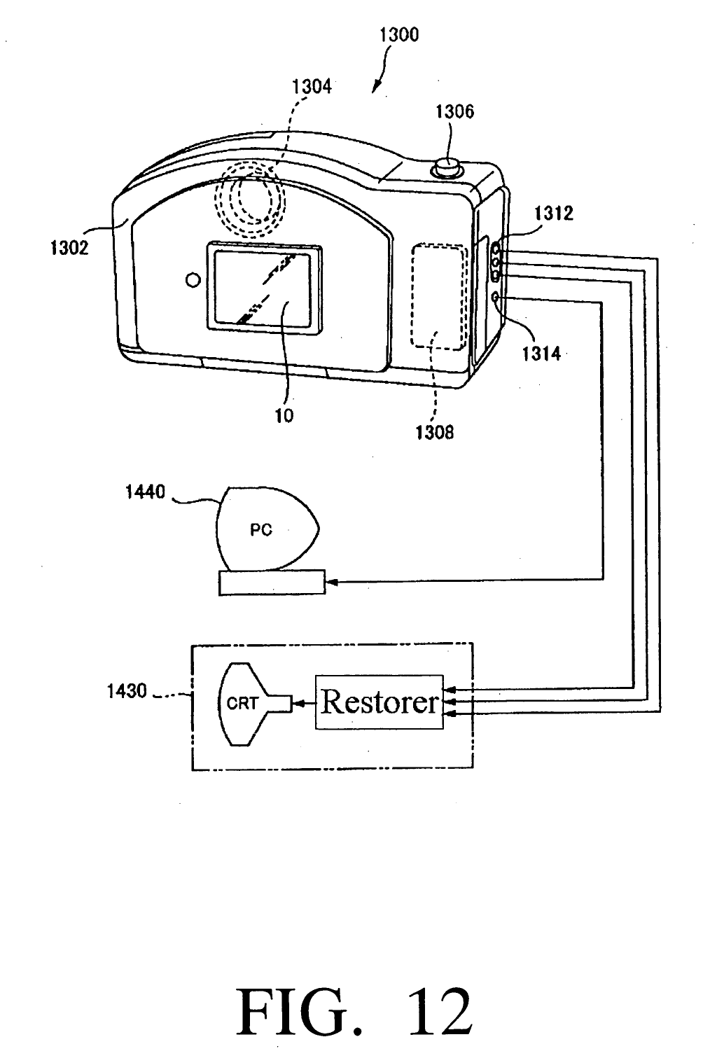

FIG. 12 is a perspective view showing a digital still camera 1300 having an electronic device according to the present invention. FIG. 12 schematically shows connection to external devices. General cameras expose a silver-salt photographic film to light from a subject. In contrast to such general cameras, the digital still camera 1300 employs an image pickup device such as a charge coupled device (CCD) for performing photoelectric conversion on light from a subject to generate image signals (picture signals).

The digital still camera 1300 includes a case (body) 1302 and the aforementioned liquid crystal display device 10 mounted on a backface of the case 1302 for displaying an image based on the image signals from the CCD. The liquid crystal display device 10 serves as a finder to display a subject as an electronic image. The case 1302 includes a circuit board 1308 housed therein. The circuit board 1308 has a memory capable of storing (memorizing) image signals. The digital still camera 1300 also has a light-receiving unit 1304 attached on a front face of the case 1302. The light-receiving unit 1304 includes optical lenses (optical system), CCD, and the like.

When a photographer sees a subject displayed in the liquid crystal display device 10 and pushes a shutter button 1306, image signals from the CCD at that moment are transferred to and stored in the memory of the circuit board 1308.

The digital still camera 1300 has video signal output terminals 1312 and a data communication input/output terminal 1314 provided on a side face of the case 1302. As shown in FIG. 12, a television monitor 1430 and a personal computer 1440 are connected to the video signal output terminals 1312 and the data communication input/output terminal 1314, respectively, as needed. Further, image signals stored in the memory of the circuit board 1308 can be outputted to the television monitor 1430 or the personal computer 1440 by predetermined operation.

In addition to the personal computer (portable personal computer) shown in FIG. 10, the cellular phone shown in FIG. 11, and the digital still camera shown in FIG. 12, an electronic device according to the present invention can be applied to various devices including televisions, video cameras, viewfinder videotape recorders, direct-view videotape recorders, laptop personal computers, car navigation systems, pagers, electronic personal organizers (including organizers having a data communication function), electronic dictionaries, electronic calculators, electronic game machines, word processors, work stations, videophones, security television monitors, electronic binoculars, POS terminals, devices having a touch panel (e.g., cash dispensers in financial institutions and automatic ticket-vending machines), medical devices (e.g., electrothermometers, sphygmomanometers, blood sugar measurement devices, electrocardiographs, ultrasonic diagnostic devices, and endoscope devices), fish finders, various measurement devices, various meters (e.g., meters in vehicles, aircrafts, and ships), flight simulators, various monitors, and projection-type display devices such as projectors.

The present invention has been described above based on the illustrated embodiments. However, the present invention is not limited to the illustrated embodiments. For example, although the electrically connecting portion 370 is connected to the conductive portion 354 of the thin-film transistor 1 in the above embodiments, the present invention is not limited to these examples and can be applied to cases where an electrically connecting portion is connected to any terminal of a switching device. For example, the present invention is applicable to a case where an electrically connecting portion is connected directly to the drain region 318 of the thin-film transistor 1. The switching device may comprise a thin-film transistor, a thin-film diode, or the like. In a method of manufacturing a substrate for an electronic device according to the present invention, one or more processes may be added to the aforementioned steps as desired. A display device according to the present invention is not limited to a liquid crystal panel. For example, a display device according to the present invention can be applied to organic EL elements, electrophoresis display devices, or the like.

5. Example

Specific examples of the present invention will be described below.

i) First, a quartz glass substrate having thin-film transistors formed thereon as shown in FIG. 6G was prepared.

ii) Then, a liquid material in which polysilazane was dissolved into xylene so as to have a concentration of 0.5 wt % was supplied on the thin-film transistors by a spin coat method. Thereafter, the quartz glass substrate was heated at 450° C. for 15 minutes to dry the liquid material. Thus, an interlayer dielectric having an average thickness of 300 nm was formed on the thin-film transistors.

iii) Next, a negative resist, TELR-N101PM manufactured by Tokyo Ohka Kogyo Co., Ltd., was applied on the interlayer dielectric by a spin coat method. Then, an i-line (having a wavelength of 365 nm and an intensity of 120 mJ/cm²) was irradiated via a photomask corresponding to shapes of contact holes to be formed in the interlayer dielectric. Thereafter, the quartz glass substrate was developed by NMD-W (developer). Thus, a resist layer having openings at positions at which the contact holes were to be formed was obtained.

iv) Then, while the resist layer was used as a mask, the interlayer dielectric was etched by a plasma etching method to form the contact holes in the interlayer dielectric. Thereafter, the resist layer was removed.

v) Subsequently, while a target formed of ITO was placed on a cathode in a chamber, the quartz glass substrate was placed on an anode so that a surface of the quartz glass substrate on which the thin-film transistors were formed faced vertically downward. Then, ITO was supplied to the quartz glass substrate by a RF sputtering method using argon as a discharge gas. Thus, a conductive material layer of ITO having an average thickness of 100 nm was formed on a surface of the interlayer dielectric opposite to the quartz glass substrate and inside of the contact holes. In this experiment, an atomic ratio of indium and tin (indium/tin ratio) in ITO was 92.5/7.5. When the surface of the conductive material layer was measured by a step detector to detect spaces inside of the contact holes, steps having an average depth of 180 nm were observed.

vi) Then, a liquid material in which indium chloride and tin chloride were dissolved into ethanol was supplied by a spin coat method so as to fill the spaces inside of the conductive material layer within the contact holes and cover the conductive material layer. A mixing ratio of indium chloride and tin chloride (atomic ratio of indium/tin) was 92.5/7.5. Subsequently, ethanol in the liquid material was removed (dried). Thereafter, heat treatment was performed on the quartz glass substrate in a nitrogen atmosphere (non-oxidizing atmosphere) at 400° C. for 10 minutes. Thus, indium chloride and tin chloride reacted with each other into ITO (conductive material) to form a filler material layer having an average thickness of 50 nm. Although the surface of the filler material layer was measured by a step detector to detect spaces inside of the contact holes, the filler material layer had a continuous smooth surface. Thus, the filler material layer had no steps in the contact holes.

vii) Next, a treatment liquid containing tridecafluoro-1,1,2,2-tetrahydrooctyltriethoxysilane was supplied to regions excluding formation areas, in which pixel electrodes and electrically connecting portions were to be formed, on a surface of the filler material layer opposite to the quartz glass substrate by an ink-jet method. Then, heat treatment was performed on the quartz glass substrate at 100° C. for 10 minutes to dry the treatment liquid. Thus, a liquid-repellent film was formed in the regions excluding the formation areas.

viii) After the negative resist used in step iii) was applied by a spin coat method, exposure and development were performed to form a resist layer in the formation area.

ix) Then, while the resist layer formed in step vii) was used as a mask, the liquid-repellent film, the filler material layer, and the conductive material layer were collectively removed in the regions excluding the formation areas by a plasma etching method. Subsequently, the resist layer was removed. Thus, pixel electrodes and electrically connecting portions were formed on the interlayer dielectric to produce a substrate for an electronic device.

x) Next, an alignment layer made of polyimide having an average thickness of 60 nm was formed so as to cover the interlayer dielectric. Then, a rubbing process was performed on the alignment layer by a rubbing apparatus. The rubbing process was conducted under conditions having a pushing amount of 0.4 mm, a rotational speed of 600 rpm, and a feed speed of 1 m/min.

xi) Subsequently, a liquid crystal display device as shown in FIG. 2 was manufactured from the substrate having the alignment layer. Thus, five liquid crystal display devices were manufactured in this manner. Each of the liquid crystal display devices caused no display unevenness.

As a comparative example, five liquid crystal display devices were manufactured in the same manner as described above except that the filler material layer was not formed in step vi). Each of the liquid crystal display devices caused display unevenness at portions corresponding to the contact holes.

Although certain preferred embodiments of the present invention have been shown and described in detail, it should be understood that various changes and modifications may be made therein without departing from the scope of the appended claims.

What is claimed is:

1. A substrate for an electronic device, the substrate comprising:
a base substrate;
a switching device formed on the base substrate, the switching device having a terminal;
an interlayer dielectric formed so as to cover the switching device, the interlayer dielectric having a contact hole extending therethrough so as to communicate with the terminal of the switching device;
a pixel electrode formed on the interlayer dielectric; and
an electrically connecting portion connected to the pixel electrode, the electrically connecting portion including
(i) a conductive film formed on an inner surface of the contact hole and a surface of the terminal by a vapor phase process, and
(ii) a filler material filled in a space inside of the conductive film within the contact hole.

2. The substrate as recited in claim 1, wherein a surface of the electrically connecting portion which is opposite to the base substrate and a surface of the pixel electrode which is opposite to the base substrate are formed by a continuous smooth surface.

3. The substrate as recited in claim 1, wherein the conductive film of the electrically connecting portion and at least a portion of the pixel electrode are formed integrally with each other.

4. The substrate as recited in claim 1, wherein the pixel electrode has a light-transmittance.

5. The substrate as recited in claim 1, wherein the filler material mainly contains a conductive material.

6. The substrate as recited in claim 1, wherein the filler material mainly contains a transparent conductive material.

7. The substrate as recited in claim 1, wherein the pixel electrode includes a portion to which the filler material is supplied on an opposite side of the base substrate.

8. A method of manufacturing a substrate for an electronic device, the method comprising:
forming a contact hole in an interlayer dielectric covering a switching device formed on a base substrate so as to communicate with a terminal of the switching device;
supplying a conductive material by a vapor phase process to form a conductive material layer on the interlayer dielectric in a region including a formation area;
filling a filler material selectively in a space inside of the conductive material layer within the contact hole by a liquid phase process;
supplying a mask material by a liquid phase process to form a mask having a shape corresponding to the formation area; and
removing an unnecessary portion of the conductive material layer with use of the mask to form a pixel electrode and an electrically connecting portion connected to the pixel electrode on the interlayer dielectric in the formation area.

9. The method as recited in claim 8, further comprising improving a liquid-repellency to a liquid material used as the filler material on a surface of the conductive material layer opposite to the base substrate prior to the filler material filling step.

10. The method as recited in claim 8, further comprising improving a liquid-repellency to the mask material on a surface of the conductive material layer opposite to the base substrate in a region excluding the formation area prior to the mask material supplying step.

11. A method of manufacturing a substrate for an electronic device, the method comprising:
forming a contact hole in an interlayer dielectric covering a switching device formed on a base substrate so as to communicate with a terminal of the switching device;
supplying a conductive material by a vapor phase process to form a conductive material layer on the interlayer dielectric in a region including a formation area;
supplying a filler material by a liquid phase process to form a filler material layer, having a shape corresponding to the formation area, on the conductive material layer;
removing an unnecessary portion of the conductive material layer while using the filler material layer as a mask; and
removing an unnecessary portion of the filler material layer to form a pixel electrode and an electrically connecting portion connected to the pixel electrode on the interlayer dielectric in the formation area.

12. The method as recited in claim 11, further comprising improving a liquid-repellency to a liquid material used as the filler material on a surface of the conductive material layer opposite to the base substrate in a region excluding the formation area prior to the filler material supplying step.

13. A method of manufacturing a substrate for an electronic device, the method comprising:
forming a contact hole in an interlayer dielectric covering a switching device formed on a base substrate so as to communicate with a terminal of the switching device;
supplying a conductive material by a vapor phase process to form a conductive material layer on the interlayer dielectric in a region including a formation area;
supplying a filler material by a liquid phase process to form a filler material layer on the conductive material layer;
supplying a mask material by a liquid phase process to form a mask having a shape corresponding to the formation area; and
collectively removing unnecessary portions of the filler material layer and the conductive material layer with use of the mask to form a pixel electrode and an electrically connecting portion connected to the pixel electrode on the interlayer dielectric in the formation area.

14. The method as recited in claim 13, further comprising improving a liquid-repellency to the mask material on a surface of the filler material layer which is opposite to the base substrate in a region excluding the formation area prior to the mask material supplying step.

15. A display device comprising:
a first substrate including
a base substrate,
a switching device formed on the base substrate, the switching device having a terminal,
an interlayer dielectric formed so as to cover the switching device, the interlayer dielectric having a contact hole extending therethrough so as to communicate with the terminal of the switching device,
a pixel electrode formed on the interlayer dielectric, and
an electrically connecting portion connected to the pixel electrode, the electrically connecting portion including
(i) a conductive film formed on an inner surface of the contact hole and a surface of the terminal by a vapor phase process, and
(ii) a filler material filled in a space inside of the conductive film within the contact hole;
a second substrate opposed to the first substrate; and
a display area interposed between the first substrate and the second substrate.

16. An electronic device comprising:
a display device having
a first substrate including
a base substrate,
a switching device formed on the base substrate, the switching device having a terminal,
an interlayer dielectric formed so as to cover the switching device, the interlayer dielectric having a contact hole extending therethrough so as to communicate with the terminal of the switching device,
a pixel electrode formed on the interlayer dielectric, and
an electrically connecting portion connected to the pixel electrode, the electrically connecting portion including
(i) a conductive film formed on an inner surface of the contact hole and a surface of the terminal by a vapor phase process, and
(ii) a filler material filled in a space inside of the conductive film within the contact hole;
a second substrate opposed to the first substrate; and
a display area interposed between the first substrate and the second substrate.
